(19) United States
(12) Patent Application Publication
(10) Pub. No.: US 2017/0362137 A1
(43) Pub. Date: Dec. 21, 2017

(54) ZEOLITE BASED AGRICULTURAL COMPOSITION

(71) Applicant: E I DU PONT DE NEMOURS AND COMPANY, Wilmington, DE (US)

(72) Inventors: KAYLEIGH J. FERGUSON, GREENVILLE, DE (US); KATRINA KRATZ, WILMINGTON, DE (US)

(21) Appl. No.: 15/535,949

(22) PCT Filed: Dec. 3, 2015
(86) PCT No.: PCT/US15/63644

§ 371 Date: Jun. 14, 2017

Related U.S. Application Data
(60) Provisional application No. 62/093,575, filed on Dec. 18, 2014.

(51) Int. Cl. C05G 3/00; B01J 20/18; A01N 43/88; C05C 5/02; A01N 25/26

(52) U.S. Cl. CPC C05G 3/0029; C05C 5/02; A01N 25/26; A01N 43/88; B01J 20/18

(57) ABSTRACT

The present disclosure relates to zeolite based agricultural compositions and their use as delayed release compositions. The delayed release compositions comprise an agricultural composition absorbed into or on the zeolite and the impregnated zeolites can then be coated with a polymer material to give the delayed release composition. Release of the agricultural composition can be tuned to coincide with the demand needs of a growing plant.

### FIELD OF THE DISCLOSURE

The present disclosure is directed toward a delayed release composition comprising a polymer, a zeolite and an agricultural composition absorbed within and/or on the zeolite. The composition can function as a delayed release particle releasing the agricultural composition only after a prolonged time in the soil.

### BACKGROUND OF DISCLOSURE

Current agricultural practices apply a large amount of fertilizer, especially nitrogen fertilizers, to the soil prior to or during the planting of the propagule. This application of large amounts of fertilizer can prove detrimental to surrounding areas and ground water due to leaching and run off issues. The leaching and run off problems lessen the amount of fertilizer that is available to the growing plant and can cause pollution of the ground and surface waters.

Additionally, pressure from pests can require multiple applications of pesticides to combat the problems. It is especially difficult to control in large fields where entry of application equipment may injure growing plants. Multiple pests can require entry into the fields multiple times during one growing season.

There is a need for improving the delivery of both fertilizer and pesticide materials that delivers the materials in such a way that leaching and run off issues are minimized and that avoids entry into the fields during the growing season.

### SUMMARY OF THE DISCLOSURE

In some embodiments, the disclosure relates to a delayed release composition comprising:
a) a core comprising a zeolite impregnated by an agricultural composition; and
b) a layer of a polymer composition on at least a portion of the core,
wherein the agricultural composition comprises a fertilizer, macronutrients, micronutrients, a pesticide, a plant growth regulator, a Nod factor or a combination thereof, and wherein the polymer composition comprises a polymer and, wherein the polymer is a polylactic acid polymer, polylactic acid glycolic acid copolymer, polybutylene succinate adipate copolymer, a polybutylene succinate copolymer or a blend thereof.

In other embodiments, the delayed release composition comprises:
a1) a continuous matrix of a polymer composition; and
b1) dispersed within the polymer matrix, a zeolite impregnated with an agricultural composition,
wherein the agricultural composition comprises a fertilizer, macronutrients, micronutrients, a pesticide, a plant growth regulator, a Nod factor or a combination thereof, and wherein the polymer composition comprises a polymer and, wherein the polymer is a polylactic acid polymer, polylactic acid glycolic acid copolymer, polybutylene succinate adipate copolymer, a polybutylene succinate copolymer or a blend thereof.

In another embodiment, the disclosure relates to a method comprising the steps of:
i. placing a delayed release composition and a propagule in a growing medium wherein the propagule and the delayed release composition are distal to one another;
ii. allowing the propagule to germinate and the resultant plant to proliferate roots and grow;
wherein the delayed release composition comprises a delayed release composition described above, and wherein the roots of the plant elongate and proliferate at a distance which is proximal to the delayed release composition.

### BRIEF DESCRIPTION OF THE DRAWINGS

FIG. 1 shows the effect of temperature on nitrogen release from delayed release compositions.

### DETAILED DESCRIPTION

The features and advantages of the present disclosure will be more readily understood by those of ordinary skill in the art from reading the following detailed description. It is to be appreciated that certain features of the disclosure, which are, for clarity, described above and below in the context of separate embodiments, may also be provided in combination in a single element. Conversely, various features of the disclosure that are, for brevity, described in the context of a single embodiment, may also be provided separately or in any sub-combination. In addition, references to the singular may also include the plural (for example, “a” and “an” may refer to one or more) unless the context specifically states otherwise.

The use of numerical values in the various ranges specified in this application, unless expressly indicated otherwise, are stated as approximations as though the minimum and maximum values within the stated ranges were both proceeded by the word “about”. In this manner, slight variations above and below the stated ranges can be used to achieve substantially the same results as values within the ranges. Also, the disclosure of these ranges is intended as a continuous range including each and every value between the minimum and maximum values.

As used herein:

The phrase “delayed release” means a non-linear rate of release of the agricultural composition from the zeolite particle. Starting from the time that the delayed release particle is placed in a growing medium to in the range of from 1 to 8 weeks after placement in the growing medium, from 80 to 100 percent by weight of the agricultural composition is retained in the delayed release composition. After the initial 1 to 8 week period, i.e., 2 to 20 weeks after placement in the growing medium, in the range of from 80 and up to 100 percent of the agricultural composition is then released from the delayed release composition to the growing medium. In some embodiments, the delayed release is tuned to coincide with the fertilizer demand requirements of the growing plant. For example, the delayed release particle can be tuned to provide a growing corn plant with an amount of nitrogen fertilizer in order to maximize the yield of corn. In the initial stage of growth, i.e., up to about 60 days after planting, a growing corn plant requires only about 20 to 30 percent of its total nitrogen needs. However, from about day 60 up to about the harvest date, the corn plant requires 70 to 80 percent of the total nitrogen intake. The disclosed delayed release particle can provide the corn plant with an amount of nitrogen fertilizer that is timed to meet the demands of the growing plant.

The phrase “agricultural composition” means a fertilizer, macronutrients, micronutrients, a pesticide, a plant growth regulator, plant hormones, a Nod factor or a combination thereof.

The term “pesticide” refers to any chemical classified as a pesticide or active ingredient (a.i.) such as those that are under the jurisdiction of the United States of America Federal Insecticide, Fungicide and Rodenticide Act (FIFRA). The skilled worker is familiar with such pesticides, which can be found, for example, in Pesticide Manual, 15th Ed. (2009), The British Crop Protection Council, London.

As used herein, the term “propagule” means a seed or a regenerable plant part. The term “regenerable plant part” means a part of a plant other than a seed from which a whole plant may be grown or regenerated when the plant part is placed in horticultural or agricultural growing media such as, for example, moistened soil, peat moss, sand, vermiculite, perlite, rock wool, fiberglass, coconut husk fiber, tree fern fiber, or a completely liquid medium such as water. The term “geotropic propagule” means a seed or a regenerable plant part obtained from the portion of a plant ordinarily disposed below the surface of the growing medium. Geotropic regenerable plant parts include viable divisions of rhizomes, tubers, bulbs and corms which retain meristematic tissue, such as an eye. Regenerable plant parts such as cut or separated stems and leaves derived from the foliage of a plant are not geotropic and thus are not considered geotropic propagules. As referred to in the present disclosure and claims, unless otherwise indicated, the term “seed” specifically refers to an unsprouted seed or seeds. The term “foliage” refers to parts of a plant exposed above ground. Therefore foliage includes leaves, stems, branches, flowers, fruits and/or buds. The phrase “resultant plant” refers to a plant that has been grown or regenerated from a propagule that has been placed in growing media.

The term “rhizosphere” as defined herein refers to the area of soil that is directly influenced by plant roots and microorganisms in the soil surrounding the roots. The area of soil surrounding the roots is generally considered to be about 1 millimeter wide but has no distinct edge.

As used herein the phrase “biologically effective amount” refers to that amount of a substance required to produce a desired effect on a plant, on an insect, or a plant pest. Effective amounts of the substance will depend on several factors, including the treatment method, plant species, pest species, propagating material type and environmental conditions. For example, a biologically effective amount of an insecticide would be the amount of the insecticide that protects a plant from damage. This does not mean that protected plant suffers no damage from the pest, but that the damage is at such a level as to allow the plant to give an acceptable yield of a crop.

The phrase “particle size” refers to the equivalent spherical diameter of a filler particle, i.e., the diameter of a sphere enclosing the same volume as the particle. “Mean particle size” is the numerical value at which 50 percent of the mass of the particles have particle sizes which are less than or equal to the numerical value. With reference to particle size distribution, percentages of particles are also on a volume basis (for example, “at least 95 percent of the particles are less than about 10 microns” means that at least 95 percent of the aggregate volume of particles consists of particles having equivalent spherical diameters of less than about 10 microns). The principles of particle size analysis are well-known to those skilled in the art; for a technical paper providing a summary, see A. Rawle, “Basic Principles of Particle Size Analysis” (document MRK034 published by Malvern Instruments Ltd., Malvern, Worcestershire, UK). Volume distributions of particles in powders can be conveniently measured by such techniques as Low Angle Laser Light Scattering (also known as LALLS and Laser Diffraction), which relies on the fact that diffraction angle is inversely proportional to particle size. Further, the particle sizes, as referred to in the description and in the claims, are the particle sizes before the particles are incorporated into the coating composition.

The delayed release composition of the present disclosure can be of two different forms. The first form is a core/shell composition comprising or consisting essentially of:
a) a core comprising or consisting essentially of a zeolite impregnated by an agricultural composition; and
b) a shell comprising or consisting essentially of a layer of a coating composition on at least a portion of the core.

In a second embodiment, the delayed release composition comprises or consists essentially of:
a1) a continuous matrix of a polymer composition; and
b1) dispersed within the polymer matrix, a zeolite impregnated with an agricultural composition. The shell of the core/shell composition and the continuous phase of the matrix, comprises or consists essentially of a polymer composition comprising a polymer and optional additives to the polymer, wherein the polymer is a polylactic acid polymer, polylactic acid glycolic acid copolymer, polybutylene succinate adipate copolymer, a polybutylene succinate copolymer or a blend thereof. In the case of the coated core, the polymer composition is formulated to be coating composition that can be applied to the surface of the core, for example, a polylactic acid film that can be heat sealed to the impregnated zeolite. In the continuous matrix embodiment, the polymer composition is formulated to be extruded as a mixture with the impregnated zeolite.

In another embodiment, the present disclosure relates to a process for the preparation of a delayed release composition comprising or consisting essentially of the steps of:
i) impregnating a zeolite with an agricultural composition;
ii) compacting the impregnated zeolite to form a granule, bead, prill, pellet or tablet;
iii) applying a layer of a coating composition onto at least a portion of the granule, bead, prill or tablet.

In another embodiment, the present disclosure relates to a process for the preparation of a delayed release composition comprising the steps of:
i) impregnating a zeolite with an agricultural composition;
ii) combining the impregnated zeolite with a polymer composition;
iii) extruding the mixture of step iii);
iv) cooling the extruded mixture; and
v) granulating the cooled mixture.

In other embodiments, the extruded delayed release composition can further comprise the step of forming granules of the impregnated zeolite prior to step ii) combining the impregnated zeolite with a polylactic acid polymer or polylactic acid copolymer.

The impregnating and the optional compaction steps are the same as the impregnating and compaction steps as described above. In one embodiment, the step of combining the impregnated zeolite with the polymer composition can be performed by forming a mixture of pellets of the polymer composition and the impregnated zeolite. The combined mixture can then be fed to an extruder. In another embodiment, the polymer composition and the impregnated zeolite can be fed via the same or different inlets of the extruder apparatus and mixed in the extruder, followed by extrusion of a mixture of the impregnated zeolite and the polymer.

The step of impregnating the zeolite with the agricultural composition can be accomplished by contacting the zeolite with a melt of the agricultural composition or with a solution, dispersion or suspension of the agricultural composition. The solution, dispersion or suspension of the agricultural composition and the zeolite can be contacted for 5 seconds to 5 hours to ensure that the agricultural composition has been impregnated into at least a portion of the pores of the zeolite. After the contact period, the aqueous or organic carrier liquid can be removed under vacuum, by heating or by a combination thereof. This impregnation step can be carried out several times to ensure that the pores of the zeolite have absorbed the agricultural composition.

In some embodiments, an individual zeolite particle can have a single agricultural composition absorbed in the pores, while in other embodiments, a combination of agricultural compositions can be applied to each zeolite particle. The zeolite particles can be incorporated into the delayed release composition by either of the two methods described above.

In other embodiments, a single agricultural composition can be incorporated into the zeolite. The delayed release composition can then be formed, wherein several differently impregnated zeolites can be used. The differently impregnated zeolites can be combined in various ratios and formed into the delayed release composition by any of the methods described above, in order to provide the desired beneficial effects to the delayed release composition. This can be especially useful, for example, if both a fertilizer and a pesticide are used.

The step of compaction of the impregnated zeolite can be accomplished by any means known in the art. In some embodiments, small amounts of binders can be added to the impregnated zeolite in order to provide adhesion between the individual zeolite particles. Powder compaction processes are well-known in the art and any of the known processes can be used. Compaction processes can include, roller compaction or the use of a tableting machine. Roller compaction comprises the use of pressure to form a powder into bricks or sheets which can then be granulated to form smaller pieces. The pieces can be screened to sort larger particles from smaller particles. In a tableting machine, the powder, for example, the impregnated zeolite is placed in a die having a particular shape and a press compacts the powder in to a tablet having the shape of the die.

The step of applying a layer of the coating composition onto at least a portion of the granule, bead, prill or tablet, can be accomplished by spraying, flow coating, immersion coating, wrapping followed by heat sealing or any other coating methods typically used in the art. In certain embodiments, the granules, beads, prills, pellets or tablets can be placed in a rotating drum and the layer of the coating composition can be applied by spray application. A stream of air or inert gas, for example, nitrogen can be directed into the rotating drum in order to help dry the applied layer of coating composition. The gas stream can be heated or can be ambient temperature. In certain embodiments, the layer of the coating composition covers at least 95 percent of the total surface area of the granule, bead, prill, pellets or tablet. In certain embodiments, the layer covers at least 99 percent of the total surface area of the granule, bead, prill, pellet or tablet. In certain embodiments, the layer covers at least 99.5 percent of the total surface area of the granule, bead, prill, pellet or tablet, and, in certain embodiments, the layer of the coating composition covers 100 percent of the surface area of the granule, bead, prill or tablet. Small areas of the zeolite that are not coated by the coating composition can allow the agricultural composition to leach out of the zeolite prior to the desired release timing, which is undesired. The thickness of the film to be applied to the surface of the granule, bead, prill, pellet or tablet can be in the range of from 20 micrometers to 260 micrometers. In certain embodiments, the layer of the coating composition can be in the range of from 25 micrometers to 200 micrometers, and, in certain embodiments, the layer of the coating composition can be in the range of from 30 micrometers to 150 micrometers. In certain embodiments, multiple layers of thin film layers can be applied to the surface in order to provide a thicker film layer.

In processes for forming an extruded delayed release composition, the polymer composition and the impregnated zeolite can be combined in a weight ratio in the range of from 100:1 to 1:5. In other embodiments, the weight ratio of the polymer matrix to the impregnated zeolite can be in the range of from 50:1 to 1:2, and, in still further embodiments, can be in the range of from 20:1 to 1:1. Higher weight ratios of the polymer composition with respect to the impregnated zeolite favor longer growing medium contact time periods until the delayed release.

In either method of preparing the delayed release composition, the zeolite is surrounded or encapsulated by the polymer composition via a layer of the coating composition or as a part of the matrix. Several factors can generally affect the release of the agricultural composition. For example, soil temperature, soil pH, the thickness of the polymer layer, the concentration of the polymer matrix versus the agricultural composition, the polymer type and additives to the polymer composition generally affect the timing of the release. Surprisingly, as shown in Example 10, release of the agricultural composition from the delayed release compositions disclosed herein appears to be largely insensitive to temperature effects that the composition may be subjected to during a growing season.

The polymer composition is a polylactic acid polymer, a polylactic acid glycolic acid copolymer, polybutylene succinate, polybutylene succinate-co-adipate copolymer or a blend thereof. As used herein, the phrase “biodegradable polymer” means that the intrinsic viscosity of a polymer is reduced after contacting the polymer with water, light, soil, soil microbes or a combination thereof, for a given period of time compared with the intrinsic viscosity of the polymer prior to the contact with the water, light, soil, soil microbes or combination thereof.

The polymer composition can also comprise one or more additives. Suitable additives can include, for example, plasticizers, antioxidants, tougheners, colorants, fillers, impact modifiers, processing aids, stabilizers, and flame retardants. Antioxidants can include, for example, hydroquinone, IRGANOX® 1010, and vitamin E. Tougheners include but are not limited to styrenic block copolymers, BIOMAX® Strong, poly(butylene adipate terephthalate), poly(caprolactone), poly(ester urethanes), poly(caprolactone) based polyurethanes, natural rubber, HYTREL®, poly(butylene succinate), poly(butylene succinate adipate), poly(propylene glycol), plasticizers and oils. Colorants include but are not limited to pigments and dyes. Fillers include but are not limited to starch, mica and silica. Impact modifiers include but are not limited to PARALOID™ BPM-520, BIOSTRENGTH® 280, core-shell acrylics, and butadiene rubber. Processing aids include but are not limited to erucamide and stearyl erucamide. Stabilizers include, for example, UV stabilizers, hindered amine light stabilizers, antiozonants and organosulfur compounds. Flame retardants include, for example, aluminum trihydroxide (ATH), magnesium hydroxide (MDH), phosphonate esters, triphenyl phosphate, phosphate esters, ammonium pyrophosphate and melamine polyphosphate.

The zeolite is typically in the form of a powder. Zeolites can be naturally occurring or man-made porous crystalline silicates. The structure of the zeolite can be a microporous arrangement of silica and alumina tetrahedra. The pores of the zeolite are able to absorb a wide range of chemical compounds, depending on the individual pore sizes. In some embodiments, the zeolite can be clinoptilolite, phillipisite, chabazite, mordenite, zeolite X, zeolite Y or a combination thereof. In some embodiments, the zeolite comprises or consists essentially of clinoptilonite. The zeolite can have an average particle size in the range of from 0.01 micrometers to 1.0 micrometers prior to being impregnating with the agricultural composition. In other embodiments, the zeolite average particle size is in the range of from 0.02 micrometers to 0.5 micrometers, and, in still further embodiments, is in the range of from 0.03 to 0.1 micrometers. The impregnation step can result in the agglomeration of the particles which would increase the average particle size, therefore, the average particle size is determined prior to impregnation of the agricultural composition.

The agricultural composition can be incorporated into the pores of the powder by contacting the zeolite with a liquid, a melt, a solution, a suspension or a dispersion of the agricultural composition. Liquid, solution, suspension or dispersions of the agricultural composition can comprise a liquid carrier wherein the liquid carrier is aqueous, organic or a combination thereof. In some embodiments, the agricultural composition can comprise a fertilizer, macronutrients, micronutrients, a pesticide, a plant growth regulator, a Nod factor or a combination thereof.

Fertilizers are well-known in the art. Suitable fertilizers can include, for example, reduced nitrogen compounds and unreduced nitrogen compounds, phosphorous and potassium compounds, and one or more secondary nutrients, for example, sulfur, calcium, magnesium, boron, iron, copper, manganese, zinc or a combination thereof. In some embodiments, the fertilizer can be urea, ammonium chloride, ammonium nitrate, ammonium sulfate, calcium nitrate, diammonium phosphate, monoammonium phosphate, potassium chloride, potassium nitrate, potassium sulfate, monopotassium phosphate, dipotassium phosphate, tetrapotassium pyrophosphate, potassium metaphosphate, sodium nitrate or a combination thereof. In addition to the above macronutrients, micronutrients can also be included. Suitable micronutrients can include, for example, sulfur, calcium, magnesium, boron, copper, iron, manganese, molybdenum, zinc or a combination thereof. In other embodiments, the fertilizer is ammonium chloride, ammonium nitrate, ammonium sulfate, diammonium phosphate, monoammonium phosphate or a combination thereof. It has been found that the zeolites are able to protect unreduced forms of nitrogen, for example, ammonium compounds from nitrification. The delayed release of unreduced nitrogen compounds when the growing plant requires such types of fertilizer can help to increase the yield of the particular crop.

Pesticides can also be used as the agricultural composition or as a component of the agricultural composition. Suitable pesticides are those that are under the jurisdiction of the United States of America Federal Insecticide, Fungicide and Rodenticide Act (FIFRA). In some embodiments, the pesticide can be an insecticide, fungicide, nematicide, herbicide or a combination thereof. In further embodiments, the pesticide can be an insecticide, a fungicide or a combination thereof. The skilled worker is familiar with such pesticides, which can be found, for example, in Pesticide Manual, 15th Ed. (2009), The British Crop Protection Council, London. Certain herbicides are also included in order to control obligate hemiparasites of roots, for example, some species in the genera Orobanche and Striga which require a living host for germination and initial development. In some embodiments, a combination of two or more pesticides can be used. For example, both a fungicide and an insecticide can be present. In other embodiments, two different insecticides can be present, with or without the use of a fungicide. In other embodiments, the pesticide can be a systemic pesticide.

Suitable pesticides can include insecticides, for example, anthranilic diamides, N-oxides, or salts thereof, neonicotinoids, carbamates, diamides, spinosyns, phenylpyrazoles, pyrethroids, sulfoxaflor or a combination thereof. In other embodiments, the insecticide can include, for example, thiamethoxam, clothianidin, imidacloprid, acetamiprid, dinotefuran, nitenpyram, thiacloprid, thiodicarb, aldicarb, carbofuran, furadan, fenoxycarb, carbaryl, sevin, ethienocarb, fenobucarb, chlorantraniliprole, cyantraniliprole, flubendiamide, spinosad, spinetoram, lambda-cyhalothrin, gamma-cyhalothrin, tefluthrin, fipronil, pyrometrizine, deltamethrin, methiocarb, permethrin, fipronil, thiram, or a combination thereof.

The anthranilic diamide class of insecticides contains a very large number of active ingredients and any of those can be used. Two specific examples of anthranilic diamides include chlorantraniliprole and cyantraniliprole. Both of these insecticides are available from E.I. du Pont de Nemours and Company, Wilmington, Del.

In some embodiments, the pesticide can be one or more anthranilic diamides, for example, those represented by Formula 1, or N-oxides, or salts thereof:

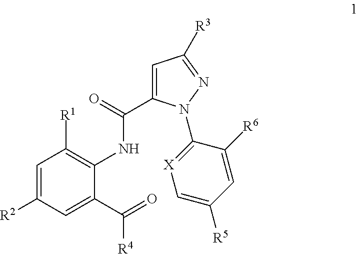

wherein
X is N, CF, CCl, CBr or CI;
R¹ is CH₃, Cl, Br or F;
R² is H, F, Cl, Br or —CN;
R³ is F, Cl, Br, C1 to C4 haloalkyl, C1 to C4 haloalkoxy or Q;
R⁴ is NR⁷R⁸, N═S(CH₃)₂, N═S(CH₂CH₃)₂, N═S(CH(CH₃)₂)₂;
R⁵ is H, F, Cl or Br;
R⁶ is H, F, Cl or Br;
each R⁷ and R⁸ is independently H, C1 to C6 alkyl, C3 to C6 cycloalkyl, cyclopropylmethyl or 1-cyclopropylethyl; and
Q is a —CH2-tetrazole radical. Suitable embodiments for Q can include any structure having a formula according to Q-1 to Q-11 in TABLE 1-1;

TABLE I-1

| | |
|---|---|
| 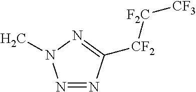 [SMILES: Cn1nnc(C(F)(F)C(F)(F)C(F)(F)F)n1] | Q-1 |
| 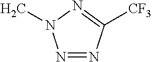 | Q-2 |
| 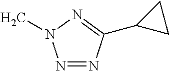 | Q-3 |
| 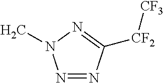 | Q-4 |
| 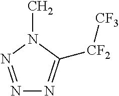 | Q-5 |
| 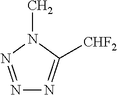 | Q-6 |
| 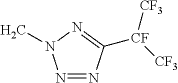 | Q-7 |
| 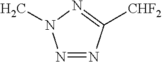 | Q-8 |
| 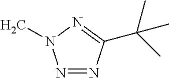 | Q-9 |
| 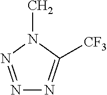 | Q-10 |
| 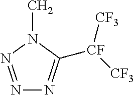 | Q-11 |

In other embodiments, the insecticide can be one or more anthranilic diamides, for example, those represented by Formula 2, or N-oxides, or salts thereof;

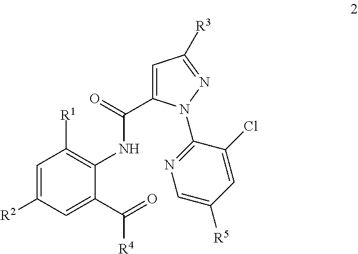

wherein
R¹ is CH₃, Cl, Br or F;
R² is H, F, Cl, Br or —CN;
R³ is F, Cl, Br, C1 to C4 haloalkyl, C1 to C4 haloalkoxy or Q;
R⁴ is NHCH₃, NHCH₂CH₃, NHCH(CH₃)₂, NHC(CH₃)₃, NHCH₂(cyclopropyl), NHCH (cyclopropyl)CH₃, N═S(CH₃)₂, N═S(CH₂CH₃)₂ or N═S(CH(CH₃)₂)₂;
R⁵ is H, F, Cl or Br.

A specific structure wherein Q is Q-2 is shown below in Formula 3;

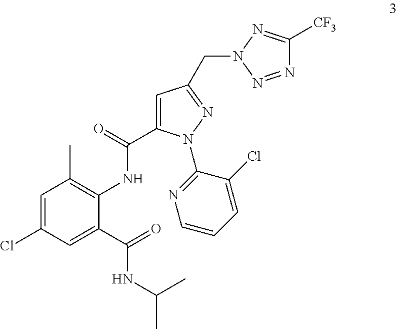 [SMILES: Cc1cc(Cl)cc(C(=O)NC(C)C)c1NC(=O)c1cc(Cn2nnc(C(F)(F)F)n2)nn1-c1ncccc1Cl]

By procedures known in the art, any of the following compounds in Table 1-2 can be produced. In Table 1-2, the following abbreviations are used: Me is methyl, Et is ethyl, Pr is propyl, i-Pr is isopropyl, c-Pr is cyclopropyl, t-Bu is tert-butyl.

TABLE I-2

| R¹ | R² | R³ | R⁴ | R⁵ | R¹ | R² | R³ | R⁴ | R⁵ |
|---|---|---|---|---|---|---|---|---|---|
| Me | Cl | Br | —NHMe | H | Me | Cl | Br | —NHMe | Cl |
| Cl | Cl | Br | —NHMe | H | Cl | Cl | Br | —NHMe | Cl |
| Br | Cl | Br | —NHMe | H | Br | Cl | Br | —NHMe | Cl |
| Me | Br | Br | —NHMe | H | Me | Br | Br | —NHMe | Cl |
| Cl | Br | Br | —NHMe | H | Cl | Br | Br | —NHMe | Cl |
| Br | Br | Br | —NHMe | H | Br | Br | Br | —NHMe | Cl |
| Me | CN | Br | —NHMe | H | Me | CN | Br | —NHMe | Cl |
| Cl | CN | Br | —NHMe | H | Cl | CN | Br | —NHMe | Cl |
| Br | CN | Br | —NHMe | H | Br | CN | Br | —NHMe | Cl |
| Me | Cl | Cl | —NHMe | H | Me | Cl | Cl | —NHMe | Cl |
| Cl | Cl | Cl | —NHMe | H | Cl | Cl | Cl | —NHMe | Cl |
| Br | Cl | Cl | —NHMe | H | Br | Cl | Cl | —NHMe | Cl |
| Me | Br | Cl | —NHMe | H | Me | Br | Cl | —NHMe | Cl |
| Cl | Br | Cl | —NHMe | H | Cl | Br | Cl | —NHMe | Cl |
| Br | Br | Cl | —NHMe | H | Br | Br | Cl | —NHMe | Cl |
| Me | CN | Cl | —NHMe | H | Me | CN | Cl | —NHMe | Cl |
| Cl | CN | Cl | —NHMe | H | Cl | CN | Cl | —NHMe | Cl |
| Br | CN | Cl | —NHMe | H | Br | CN | Cl | —NHMe | Cl |
| Me | Cl | CF₃ | —NHMe | H | Me | Cl | CF₃ | —NHMe | Cl |
| Cl | Cl | CF₃ | —NHMe | H | Cl | Cl | CF₃ | —NHMe | Cl |
| Br | Cl | CF₃ | —NHMe | H | Br | Cl | CF₃ | —NHMe | Cl |
| Me | Br | CF₃ | —NHMe | H | Me | Br | CF₃ | —NHMe | Cl |
| Cl | Br | CF₃ | —NHMe | H | Cl | Br | CF₃ | —NHMe | Cl |
| Br | Br | CF₃ | —NHMe | H | Br | Br | CF₃ | —NHMe | Cl |
| Me | CN | CF₃ | —NHMe | H | Me | CN | CF₃ | —NHMe | Cl |
| Cl | CN | CF₃ | —NHMe | H | Cl | CN | CF₃ | —NHMe | Cl |
| Br | CN | CF₃ | —NHMe | H | Br | CN | CF₃ | —NHMe | Cl |
| Me | Cl | Q-2 | —NHMe | H | Me | Cl | Q-2 | —NHMe | Cl |
| Cl | Cl | Q-2 | —NHMe | H | Cl | Cl | Q-2 | —NHMe | Cl |
| Br | Cl | Q-2 | —NHMe | H | Br | Cl | Q-2 | —NHMe | Cl |
| Me | Br | Q-2 | —NHMe | H | Me | Br | Q-2 | —NHMe | Cl |
| Cl | Br | Q-2 | —NHMe | H | Cl | Br | Q-2 | —NHMe | Cl |
| Br | Br | Q-2 | —NHMe | H | Br | Br | Q-2 | —NHMe | Cl |
| Me | CN | Q-2 | —NHMe | H | Me | CN | Q-2 | —NHMe | Cl |
| Cl | CN | Q-2 | —NHMe | H | Cl | CN | Q-2 | —NHMe | Cl |
| Br | CN | Q-2 | —NHMe | H | Br | CN | Q-2 | —NHMe | Cl |
| Me | Cl | Br | —NHEt | H | Me | Cl | Br | —NHEt | Cl |
| Cl | Cl | Br | —NHEt | H | Cl | Cl | Br | —NHEt | Cl |
| Br | Cl | Br | —NHEt | H | Br | Cl | Br | —NHEt | Cl |
| Me | Br | Br | —NHEt | H | Me | Br | Br | —NHEt | Cl |
| Cl | Br | Br | —NHEt | H | Cl | Br | Br | —NHEt | Cl |
| Br | Br | Br | —NHEt | H | Br | Br | Br | —NHEt | Cl |
| Me | CN | Br | —NHEt | H | Me | CN | Br | —NHEt | Cl |
| Cl | CN | Br | —NHEt | H | Cl | CN | Br | —NHEt | Cl |
| Br | CN | Br | —NHEt | H | Br | CN | Br | —NHEt | Cl |
| Me | Cl | Cl | —NHEt | H | Me | Cl | Cl | —NHEt | Cl |
| Cl | Cl | Cl | —NHEt | H | Cl | Cl | Cl | —NHEt | Cl |
| Br | Cl | Cl | —NHEt | H | Br | Cl | Cl | —NHEt | Cl |
| Me | Br | Cl | —NHEt | H | Me | Br | Cl | —NHEt | Cl |
| Cl | Br | Cl | —NHEt | H | Cl | Br | Cl | —NHEt | Cl |
| Br | Br | Cl | —NHEt | H | Br | Br | Cl | —NHEt | Cl |
| Me | CN | Cl | —NHEt | H | Me | CN | Cl | —NHEt | Cl |
| Cl | CN | Cl | —NHEt | H | Cl | CN | Cl | —NHEt | Cl |
| Br | CN | Cl | —NHEt | H | Br | CN | Cl | —NHEt | Cl |
| Me | Cl | CF₃ | —NHEt | H | Me | Cl | CF₃ | —NHEt | Cl |
| Cl | Cl | CF₃ | —NHEt | H | Cl | Cl | CF₃ | —NHEt | Cl |
| Br | Cl | CF₃ | —NHEt | H | Br | Cl | CF₃ | —NHEt | Cl |
| Me | Br | CF₃ | —NHEt | H | Me | Br | CF₃ | —NHEt | Cl |
| Cl | Br | CF₃ | —NHEt | H | Cl | Br | CF₃ | —NHEt | Cl |
| Br | Br | CF₃ | —NHEt | H | Br | Br | CF₃ | —NHEt | Cl |
| Me | CN | CF₃ | —NHEt | H | Me | CN | CF₃ | —NHEt | Cl |
| Cl | CN | CF₃ | —NHEt | H | Cl | CN | CF₃ | —NHEt | Cl |
| Br | CN | CF₃ | —NHEt | H | Br | CN | CF₃ | —NHEt | Cl |
| Me | Cl | Q-2 | —NHEt | H | Me | Cl | Q-2 | —NHEt | Cl |
| Cl | Cl | Q-2 | —NHEt | H | Cl | Cl | Q-2 | —NHEt | Cl |
| Br | Cl | Q-2 | —NHEt | H | Br | Cl | Q-2 | —NHEt | Cl |
| Me | Br | Q-2 | —NHEt | H | Me | Br | Q-2 | —NHEt | Cl |
| Cl | Br | Q-2 | —NHEt | H | Cl | Br | Q-2 | —NHEt | Cl |
| Br | Br | Q-2 | —NHEt | H | Br | Br | Q-2 | —NHEt | Cl |
| Me | CN | Q-2 | —NHEt | H | Me | CN | Q-2 | —NHEt | Cl |
| Cl | CN | Q-2 | —NHEt | H | Cl | CN | Q-2 | —NHEt | Cl |
| Br | CN | Q-2 | —NHEt | H | Br | CN | Q-2 | —NHEt | Cl |
| Me | Cl | Br | —NH(i-Pr) | H | Me | Cl | Br | —NH(i-Pr) | Cl |
| Cl | Cl | Br | —NH(i-Pr) | H | Cl | Cl | Br | —NH(i-Pr) | Cl |
| Br | Cl | Br | —NH(i-Pr) | H | Br | Cl | Br | —NH(i-Pr) | Cl |
| Me | Br | Br | —NH(i-Pr) | H | Me | Br | Br | —NH(i-Pr) | Cl |
| Cl | Br | Br | —NH(i-Pr) | H | Cl | Br | Br | —NH(i-Pr) | Cl |
| Br | Br | Br | —NH(i-Pr) | H | Br | Br | Br | —NH(i-Pr) | Cl |
| Me | CN | Br | —NH(i-Pr) | H | Me | CN | Br | —NH(i-Pr) | Cl |
| Cl | CN | Br | —NH(i-Pr) | H | Cl | CN | Br | —NH(i-Pr) | Cl |
| Br | CN | Br | —NH(i-Pr) | H | Br | CN | Br | —NH(i-Pr) | Cl |
| Me | Cl | Cl | —NH(i-Pr) | H | Me | Cl | Cl | —NH(i-Pr) | Cl |
| Cl | Cl | Cl | —NH(i-Pr) | H | Cl | Cl | Cl | —NH(i-Pr) | Cl |
| Br | Cl | Cl | —NH(i-Pr) | H | Br | Cl | Cl | —NH(i-Pr) | Cl |
| Me | Br | Cl | —NH(i-Pr) | H | Me | Br | Cl | —NH(i-Pr) | Cl |
| Cl | Br | Cl | —NH(i-Pr) | H | Cl | Br | Cl | —NH(i-Pr) | Cl |
| Br | Br | Cl | —NH(i-Pr) | H | Br | Br | Cl | —NH(i-Pr) | Cl |
| Me | CN | Cl | —NH(i-Pr) | H | Me | CN | Cl | —NH(i-Pr) | Cl |
| Cl | CN | Cl | —NH(i-Pr) | H | Cl | CN | Cl | —NH(i-Pr) | Cl |
| Br | CN | Cl | —NH(i-Pr) | H | Br | CN | Cl | —NH(i-Pr) | Cl |
| Me | Cl | CF₃ | —NH(i-Pr) | H | Me | Cl | CF₃ | —NH(i-Pr) | Cl |
| Cl | Cl | CF₃ | —NH(i-Pr) | H | Cl | Cl | CF₃ | —NH(i-Pr) | Cl |
| Br | Cl | CF₃ | —NH(i-Pr) | H | Br | Cl | CF₃ | —NH(i-Pr) | Cl |
| Me | Br | CF₃ | —NH(i-Pr) | H | Me | Br | CF₃ | —NH(i-Pr) | Cl |
| Cl | Br | CF₃ | —NH(i-Pr) | H | Cl | Br | CF₃ | —NH(i-Pr) | Cl |
| Br | Br | CF₃ | —NH(i-Pr) | H | Br | Br | CF₃ | —NH(i-Pr) | Cl |
| Me | CN | CF₃ | —NH(i-Pr) | H | Me | CN | CF₃ | —NH(i-Pr) | Cl |
| Cl | CN | CF₃ | —NH(i-Pr) | H | Cl | CN | CF₃ | —NH(i-Pr) | Cl |
| Br | CN | CF₃ | —NH(i-Pr) | H | Br | CN | CF₃ | —NH(i-Pr) | Cl |
| Me | Cl | Q-2 | —NH(i-Pr) | H | Me | Cl | Q-2 | —NH(i-Pr) | Cl |
| Cl | Cl | Q-2 | —NH(i-Pr) | H | Cl | Cl | Q-2 | —NH(i-Pr) | Cl |
| Br | Cl | Q-2 | —NH(i-Pr) | H | Br | Cl | Q-2 | —NH(i-Pr) | Cl |
| Me | Br | Q-2 | —NH(i-Pr) | H | Me | Br | Q-2 | —NH(i-Pr) | Cl |
| Cl | Br | Q-2 | —NH(i-Pr) | H | Cl | Br | Q-2 | —NH(i-Pr) | Cl |
| Br | Br | Q-2 | —NH(i-Pr) | H | Br | Br | Q-2 | —NH(i-Pr) | Cl |
| Me | CN | Q-2 | —NH(i-Pr) | H | Me | CN | Q-2 | —NH(i-Pr) | Cl |
| Cl | CN | Q-2 | —NH(i-Pr) | H | Cl | CN | Q-2 | —NH(i-Pr) | Cl |
| Br | CN | Q-2 | —NH(i-Pr) | H | Br | CN | Q-2 | —NH(i-Pr) | Cl |
| Me | Cl | Br | —NH(t-Bu) | H | Me | Cl | Br | —NH(t-Bu) | Cl |
| Cl | Cl | Br | —NH(t-Bu) | H | Cl | Cl | Br | —NH(t-Bu) | Cl |
| Br | Cl | Br | —NH(t-Bu) | H | Br | Cl | Br | —NH(t-Bu) | Cl |
| Me | Br | Br | —NH(t-Bu) | H | Me | Br | Br | —NH(t-Bu) | Cl |
| Cl | Br | Br | —NH(t-Bu) | H | Cl | Br | Br | —NH(t-Bu) | Cl |
| Br | Br | Br | —NH(t-Bu) | H | Br | Br | Br | —NH(t-Bu) | Cl |
| Me | CN | Br | —NH(t-Bu) | H | Me | CN | Br | —NH(t-Bu) | Cl |
| Cl | CN | Br | —NH(t-Bu) | H | Cl | CN | Br | —NH(t-Bu) | Cl |
| Br | CN | Br | —NH(t-Bu) | H | Br | CN | Br | —NH(t-Bu) | Cl |
| Me | Cl | Cl | —NH(t-Bu) | H | Me | Cl | Cl | —NH(t-Bu) | Cl |
| Cl | Cl | Cl | —NH(t-Bu) | H | Cl | Cl | Cl | —NH(t-Bu) | Cl |
| Br | Cl | Cl | —NH(t-Bu) | H | Br | Cl | Cl | —NH(t-Bu) | Cl |
| Me | Br | Cl | —NH(t-Bu) | H | Me | Br | Cl | —NH(t-Bu) | Cl |
| Cl | Br | Cl | —NH(t-Bu) | H | Cl | Br | Cl | —NH(t-Bu) | Cl |
| Br | Br | Cl | —NH(t-Bu) | H | Br | Br | Cl | —NH(t-Bu) | Cl |
| Me | CN | Cl | —NH(t-Bu) | H | Me | CN | Cl | —NH(t-Bu) | Cl |
| Cl | CN | Cl | —NH(t-Bu) | H | Cl | CN | Cl | —NH(t-Bu) | Cl |
| Br | CN | Cl | —NH(t-Bu) | H | Br | CN | Cl | —NH(t-Bu) | Cl |
| Me | Cl | CF₃ | —NH(t-Bu) | H | Me | Cl | CF₃ | —NH(t-Bu) | Cl |
| Cl | Cl | CF₃ | —NH(t-Bu) | H | Cl | Cl | CF₃ | —NH(t-Bu) | Cl |
| Br | Cl | CF₃ | —NH(t-Bu) | H | Br | Cl | CF₃ | —NH(t-Bu) | Cl |
| Me | Br | CF₃ | —NH(t-Bu) | H | Me | Br | CF₃ | —NH(t-Bu) | Cl |
| Cl | Br | CF₃ | —NH(t-Bu) | H | Cl | Br | CF₃ | —NH(t-Bu) | Cl |
| Br | Br | CF₃ | —NH(t-Bu) | H | Br | Br | CF₃ | —NH(t-Bu) | Cl |
| Me | CN | CF₃ | —NH(t-Bu) | H | Me | CN | CF₃ | —NH(t-Bu) | Cl |
| Cl | CN | CF₃ | —NH(t-Bu) | H | Cl | CN | CF₃ | —NH(t-Bu) | Cl |
| Br | CN | CF₃ | —NH(t-Bu) | H | Br | CN | CF₃ | —NH(t-Bu) | Cl |
| Me | Cl | Q-2 | —NH(t-Bu) | H | Me | Cl | Q-2 | —NH(t-Bu) | Cl |
| Cl | Cl | Q-2 | —NH(t-Bu) | H | Cl | Cl | Q-2 | —NH(t-Bu) | Cl |
| Br | Cl | Q-2 | —NH(t-Bu) | H | Br | Cl | Q-2 | —NH(t-Bu) | Cl |
| Me | Br | Q-2 | —NH(t-Bu) | H | Me | Br | Q-2 | —NH(t-Bu) | Cl |
| Cl | Br | Q-2 | —NH(t-Bu) | H | Cl | Br | Q-2 | —NH(t-Bu) | Cl |
| Br | Br | Q-2 | —NH(t-Bu) | H | Br | Br | Q-2 | —NH(t-Bu) | Cl |
| Me | CN | Q-2 | —NH(t-Bu) | H | Me | CN | Q-2 | —NH(t-Bu) | Cl |
| Cl | CN | Q-2 | —NH(t-Bu) | H | Cl | CN | Q-2 | —NH(t-Bu) | Cl |
| Br | CN | Q-2 | —NH(t-Bu) | H | Br | CN | Q-2 | —NH(t-Bu) | Cl |
| Me | Cl | Br | —NHCH₂(c-Pr) | H | Me | Cl | Br | —NHCH₂(c-Pr) | Cl |
| Cl | Cl | Br | —NHCH₂(c-Pr) | H | Cl | Cl | Br | —NHCH₂(c-Pr) | Cl |
| Br | Cl | Br | —NHCH₂(c-Pr) | H | Br | Cl | Br | —NHCH₂(c-Pr) | Cl |
| Me | Br | Br | —NHCH₂(c-Pr) | H | Me | Br | Br | —NHCH₂(c-Pr) | Cl |
| Cl | Br | Br | —NHCH₂(c-Pr) | H | Cl | Br | Br | —NHCH₂(c-Pr) | Cl |
| Br | Br | Br | —NHCH₂(c-Pr) | H | Br | Br | Br | —NHCH₂(c-Pr) | Cl |
| Me | CN | Br | —NHCH₂(c-Pr) | H | Me | CN | Br | —NHCH₂(c-Pr) | Cl |
| Cl | CN | Br | —NHCH₂(c-Pr) | H | Cl | CN | Br | —NHCH₂(c-Pr) | Cl |
| Br | CN | Br | —NHCH₂(c-Pr) | H | Br | CN | Br | —NHCH₂(c-Pr) | Cl |
| Me | Cl | Cl | —NHCH₂(c-Pr) | H | Me | Cl | Cl | —NHCH₂(c-Pr) | Cl |
| Cl | Cl | Cl | —NHCH₂(c-Pr) | H | Cl | Cl | Cl | —NHCH₂(c-Pr) | Cl |
| Br | Cl | Cl | —NHCH₂(c-Pr) | H | Br | Cl | Cl | —NHCH₂(c-Pr) | Cl |
| Me | Br | Cl | —NHCH₂(c-Pr) | H | Me | Br | Cl | —NHCH₂(c-Pr) | Cl |
| Cl | Br | Cl | —NHCH₂(c-Pr) | H | Cl | Br | Cl | —NHCH₂(c-Pr) | Cl |
| Br | Br | Cl | —NHCH₂(c-Pr) | H | Br | Br | Cl | —NHCH₂(c-Pr) | Cl |
| Me | CN | Cl | —NHCH₂(c-Pr) | H | Me | CN | Cl | —NHCH₂(c-Pr) | Cl |
| Cl | CN | Cl | —NHCH₂(c-Pr) | H | Cl | CN | Cl | —NHCH₂(c-Pr) | Cl |
| Br | CN | Cl | —NHCH₂(c-Pr) | H | Br | CN | Cl | —NHCH₂(c-Pr) | Cl |
| Me | Cl | CF₃ | —NHCH₂(c-Pr) | H | Me | Cl | CF₃ | —NHCH₂(c-Pr) | Cl |
| Cl | Cl | CF₃ | —NHCH₂(c-Pr) | H | Cl | Cl | CF₃ | —NHCH₂(c-Pr) | Cl |
| Br | Cl | CF₃ | —NHCH₂(c-Pr) | H | Br | Cl | CF₃ | —NHCH₂(c-Pr) | Cl |
| Me | Br | CF₃ | —NHCH₂(c-Pr) | H | Me | Br | CF₃ | —NHCH₂(c-Pr) | Cl |
| Cl | Br | CF₃ | —NHCH₂(c-Pr) | H | Cl | Br | CF₃ | —NHCH₂(c-Pr) | Cl |
| Br | Br | CF₃ | —NHCH₂(c-Pr) | H | Br | Br | CF₃ | —NHCH₂(c-Pr) | Cl |
| Me | CN | CF₃ | —NHCH₂(c-Pr) | H | Me | CN | CF₃ | —NHCH₂(c-Pr) | Cl |
| Cl | CN | CF₃ | —NHCH₂(c-Pr) | H | Cl | CN | CF₃ | —NHCH₂(c-Pr) | Cl |
| Br | CN | CF₃ | —NHCH₂(c-Pr) | H | Br | CN | CF₃ | —NHCH₂(c-Pr) | Cl |
| Me | Cl | Q-2 | —NHCH₂(c-Pr) | H | Me | Cl | Q-2 | —NHCH₂(c-Pr) | Cl |
| Cl | Cl | Q-2 | —NHCH₂(c-Pr) | H | Cl | Cl | Q-2 | —NHCH₂(c-Pr) | Cl |
| Br | Cl | Q-2 | —NHCH₂(c-Pr) | H | Br | Cl | Q-2 | —NHCH₂(c-Pr) | Cl |
| Me | Br | Q-2 | —NHCH₂(c-Pr) | H | Me | Br | Q-2 | —NHCH₂(c-Pr) | Cl |
| Cl | Br | Q-2 | —NHCH₂(c-Pr) | H | Cl | Br | Q-2 | —NHCH₂(c-Pr) | Cl |
| Br | Br | Q-2 | —NHCH₂(c-Pr) | H | Br | Br | Q-2 | —NHCH₂(c-Pr) | Cl |
| Me | CN | Q-2 | —NHCH₂(c-Pr) | H | Me | CN | Q-2 | —NHCH₂(c-Pr) | Cl |
| Cl | CN | Q-2 | —NHCH₂(c-Pr) | H | Cl | CN | Q-2 | —NHCH₂(c-Pr) | Cl |
| Br | CN | Q-2 | —NHCH₂(c-Pr) | H | Br | CN | Q-2 | —NHCH₂(c-Pr) | Cl |
| Me | Cl | Br | —NHCH(c-Pr)Me | H | Me | Cl | Br | —NHCH(c-Pr)Me | Cl |
| Cl | Cl | Br | —NHCH(c-Pr)Me | H | Cl | Cl | Br | —NHCH(c-Pr)Me | Cl |
| Br | Cl | Br | —NHCH(c-Pr)Me | H | Br | Cl | Br | —NHCH(c-Pr)Me | Cl |
| Me | Br | Br | —NHCH(c-Pr)Me | H | Me | Br | Br | —NHCH(c-Pr)Me | Cl |
| Cl | Br | Br | —NHCH(c-Pr)Me | H | Cl | Br | Br | —NHCH(c-Pr)Me | Cl |
| Br | Br | Br | —NHCH(c-Pr)Me | H | Br | Br | Br | —NHCH(c-Pr)Me | Cl |
| Me | CN | Br | —NHCH(c-Pr)Me | H | Me | CN | Br | —NHCH(c-Pr)Me | Cl |
| Cl | CN | Br | —NHCH(c-Pr)Me | H | Cl | CN | Br | —NHCH(c-Pr)Me | Cl |
| Br | CN | Br | —NHCH(c-Pr)Me | H | Br | CN | Br | —NHCH(c-Pr)Me | Cl |
| Me | Cl | Cl | —NHCH(c-Pr)Me | H | Me | Cl | Cl | —NHCH(c-Pr)Me | Cl |
| Cl | Cl | Cl | —NHCH(c-Pr)Me | H | Cl | Cl | Cl | —NHCH(c-Pr)Me | Cl |
| Br | Cl | Cl | —NHCH(c-Pr)Me | H | Br | Cl | Cl | —NHCH(c-Pr)Me | Cl |
| Me | Br | Cl | —NHCH(c-Pr)Me | H | Me | Br | Cl | —NHCH(c-Pr)Me | Cl |
| Cl | Br | Cl | —NHCH(c-Pr)Me | H | Cl | Br | Cl | —NHCH(c-Pr)Me | Cl |
| Br | Br | Cl | —NHCH(c-Pr)Me | H | Br | Br | Cl | —NHCH(c-Pr)Me | Cl |
| Me | CN | Cl | —NHCH(c-Pr)Me | H | Me | CN | Cl | —NHCH(c-Pr)Me | Cl |
| Cl | CN | Cl | —NHCH(c-Pr)Me | H | Cl | CN | Cl | —NHCH(c-Pr)Me | Cl |
| Br | CN | Cl | —NHCH(c-Pr)Me | H | Br | CN | Cl | —NHCH(c-Pr)Me | Cl |
| Me | Cl | CF₃ | —NHCH(c-Pr)Me | H | Me | Cl | CF₃ | —NHCH(c-Pr)Me | Cl |
| Cl | Cl | CF₃ | —NHCH(c-Pr)Me | H | Cl | Cl | CF₃ | —NHCH(c-Pr)Me | Cl |
| Br | Cl | CF₃ | —NHCH(c-Pr)Me | H | Br | Cl | CF₃ | —NHCH(c-Pr)Me | Cl |
| Me | Br | CF₃ | —NHCH(c-Pr)Me | H | Me | Br | CF₃ | —NHCH(c-Pr)Me | Cl |
| Cl | Br | CF₃ | —NHCH(c-Pr)Me | H | Cl | Br | CF₃ | —NHCH(c-Pr)Me | Cl |
| Br | Br | CF₃ | —NHCH(c-Pr)Me | H | Br | Br | CF₃ | —NHCH(c-Pr)Me | Cl |
| Me | CN | CF₃ | —NHCH(c-Pr)Me | H | Me | CN | CF₃ | —NHCH(c-Pr)Me | Cl |
| Cl | CN | CF₃ | —NHCH(c-Pr)Me | H | Cl | CN | CF₃ | —NHCH(c-Pr)Me | Cl |
| Br | CN | CF₃ | —NHCH(c-Pr)Me | H | Br | CN | CF₃ | —NHCH(c-Pr)Me | Cl |
| Me | Cl | Q-2 | —NHCH(c-Pr)Me | H | Me | Cl | Q-2 | —NHCH(c-Pr)Me | Cl |
| Cl | Cl | Q-2 | —NHCH(c-Pr)Me | H | Cl | Cl | Q-2 | —NHCH(c-Pr)Me | Cl |
| Br | Cl | Q-2 | —NHCH(c-Pr)Me | H | Br | Cl | Q-2 | —NHCH(c-Pr)Me | Cl |
| Me | Br | Q-2 | —NHCH(c-Pr)Me | H | Me | Br | Q-2 | —NHCH(c-Pr)Me | Cl |
| Cl | Br | Q-2 | —NHCH(c-Pr)Me | H | Cl | Br | Q-2 | —NHCH(c-Pr)Me | Cl |
| Br | Br | Q-2 | —NHCH(c-Pr)Me | H | Br | Br | Q-2 | —NHCH(c-Pr)Me | Cl |
| Me | CN | Q-2 | —NHCH(c-Pr)Me | H | Me | CN | Q-2 | —NHCH(c-Pr)Me | Cl |
| Cl | CN | Q-2 | —NHCH(c-Pr)Me | H | Cl | CN | Q-2 | —NHCH(c-Pr)Me | Cl |
| Br | CN | Q-2 | —NHCH(c-Pr)Me | H | Br | CN | Q-2 | —NHCH(c-Pr)Me | Cl |
| Me | Cl | Br | —N═S(Me)₂ | H | Me | Cl | Br | —N═S(Me)₂ | Cl |
| Cl | Cl | Br | —N═S(Me)₂ | H | Cl | Cl | Br | —N═S(Me)₂ | Cl |
| Br | Cl | Br | —N═S(Me)₂ | H | Br | Cl | Br | —N═S(Me)₂ | Cl |
| Me | Br | Br | —N═S(Me)₂ | H | Me | Br | Br | —N═S(Me)₂ | Cl |
| Cl | Br | Br | —N═S(Me)₂ | H | Cl | Br | Br | —N═S(Me)₂ | Cl |
| Br | Br | Br | —N═S(Me)₂ | H | Br | Br | Br | —N═S(Me)₂ | Cl |
| Me | CN | Br | —N═S(Me)₂ | H | Me | CN | Br | —N═S(Me)₂ | Cl |
| Cl | CN | Br | —N═S(Me)₂ | H | Cl | CN | Br | —N═S(Me)₂ | Cl |
| Br | CN | Br | —N═S(Me)₂ | H | Br | CN | Br | —N═S(Me)₂ | Cl |
| Me | Cl | Cl | —N═S(Me)₂ | H | Me | Cl | Cl | —N═S(Me)₂ | Cl |
| Cl | Cl | Cl | —N═S(Me)₂ | H | Cl | Cl | Cl | —N═S(Me)₂ | Cl |
| Br | Cl | Cl | —N═S(Me)₂ | H | Br | Cl | Cl | —N═S(Me)₂ | Cl |
| Me | Br | Cl | —N═S(Me)₂ | H | Me | Br | Cl | —N═S(Me)₂ | Cl |
| Cl | Br | Cl | —N═S(Me)₂ | H | Cl | Br | Cl | —N═S(Me)₂ | Cl |
| Br | Br | Cl | —N═S(Me)₂ | H | Br | Br | Cl | —N═S(Me)₂ | Cl |
| Me | CN | Cl | —N═S(Me)₂ | H | Me | CN | Cl | —N═S(Me)₂ | Cl |
| Cl | CN | Cl | —N═S(Me)₂ | H | Cl | CN | Cl | —N═S(Me)₂ | Cl |
| Br | CN | Cl | —N═S(Me)₂ | H | Br | CN | Cl | —N═S(Me)₂ | Cl |
| Me | Cl | CF₃ | —N═S(Me)₂ | H | Me | Cl | CF₃ | —N═S(Me)₂ | Cl |
| Cl | Cl | CF₃ | —N═S(Me)₂ | H | Cl | Cl | CF₃ | —N═S(Me)₂ | Cl |
| Br | Cl | CF₃ | —N═S(Me)₂ | H | Br | Cl | CF₃ | —N═S(Me)₂ | Cl |
| Me | Br | CF₃ | —N═S(Me)₂ | H | Me | Br | CF₃ | —N═S(Me)₂ | Cl |
| Cl | Br | CF₃ | —N═S(Me)₂ | H | Cl | Br | CF₃ | —N═S(Me)₂ | Cl |
| Br | Br | CF₃ | —N═S(Me)₂ | H | Br | Br | CF₃ | —N═S(Me)₂ | Cl |
| Me | CN | CF₃ | —N═S(Me)₂ | H | Me | CN | CF₃ | —N═S(Me)₂ | Cl |
| Cl | CN | CF₃ | —N═S(Me)₂ | H | Cl | CN | CF₃ | —N═S(Me)₂ | Cl |
| Br | CN | CF₃ | —N═S(Me)₂ | H | Br | CN | CF₃ | —N═S(Me)₂ | Cl |
| Me | Cl | Q-2 | —N═S(Me)₂ | H | Me | Cl | Q-2 | —N═S(Me)₂ | Cl |
| Cl | Cl | Q-2 | —N═S(Me)₂ | H | Cl | Cl | Q-2 | —N═S(Me)₂ | Cl |
| Br | Cl | Q-2 | —N═S(Me)₂ | H | Br | Cl | Q-2 | —N═S(Me)₂ | Cl |
| Me | Br | Q-2 | —N═S(Me)₂ | H | Me | Br | Q-2 | —N═S(Me)₂ | Cl |
| Cl | Br | Q-2 | —N═S(Me)₂ | H | Cl | Br | Q-2 | —N═S(Me)₂ | Cl |
| Br | Br | Q-2 | —N═S(Me)₂ | H | Br | Br | Q-2 | —N═S(Me)₂ | Cl |
| Me | CN | Q-2 | —N═S(Me)₂ | H | Me | CN | Q-2 | —N═S(Me)₂ | Cl |
| Cl | CN | Q-2 | —N═S(Me)₂ | H | Cl | CN | Q-2 | —N═S(Me)₂ | Cl |
| Br | CN | Q-2 | —N═S(Me)₂ | H | Br | CN | Q-2 | —N═S(Me)₂ | Cl |
| Me | Cl | Br | —N═S(Et)₂ | H | Me | Cl | Br | —N═S(Et)₂ | Cl |
| Cl | Cl | Br | —N═S(Et)₂ | H | Cl | Cl | Br | —N═S(Et)₂ | Cl |
| Br | Cl | Br | —N═S(Et)₂ | H | Br | Cl | Br | —N═S(Et)₂ | Cl |
| Me | Br | Br | —N═S(Et)₂ | H | Me | Br | Br | —N═S(Et)₂ | Cl |
| Cl | Br | Br | —N═S(Et)₂ | H | Cl | Br | Br | —N═S(Et)₂ | Cl |
| Br | Br | Br | —N═S(Et)₂ | H | Br | Br | Br | —N═S(Et)₂ | Cl |
| Me | CN | Br | —N═S(Et)₂ | H | Me | CN | Br | —N═S(Et)₂ | Cl |
| Cl | CN | Br | —N═S(Et)₂ | H | Cl | CN | Br | —N═S(Et)₂ | Cl |
| Br | CN | Br | —N═S(Et)₂ | H | Br | CN | Br | —N═S(Et)₂ | Cl |
| Me | Cl | Cl | —N═S(Et)₂ | H | Me | Cl | Cl | —N═S(Et)₂ | Cl |
| Cl | Cl | Cl | —N═S(Et)₂ | H | Cl | Cl | Cl | —N═S(Et)₂ | Cl |
| Br | Cl | Cl | —N═S(Et)₂ | H | Br | Cl | Cl | —N═S(Et)₂ | Cl |
| Me | Br | Cl | —N═S(Et)₂ | H | Me | Br | Cl | —N═S(Et)₂ | Cl |
| Cl | Br | Cl | —N═S(Et)₂ | H | Cl | Br | Cl | —N═S(Et)₂ | Cl |
| Br | Br | Cl | —N═S(Et)₂ | H | Br | Br | Cl | —N═S(Et)₂ | Cl |
| Me | CN | Cl | —N═S(Et)₂ | H | Me | CN | Cl | —N═S(Et)₂ | Cl |
| Cl | CN | Cl | —N═S(Et)₂ | H | Cl | CN | Cl | —N═S(Et)₂ | Cl |
| Br | CN | Cl | —N═S(Et)₂ | H | Br | CN | Cl | —N═S(Et)₂ | Cl |
| Me | Cl | CF₃ | —N═S(Et)₂ | H | Me | Cl | CF₃ | —N═S(Et)₂ | Cl |
| Cl | Cl | CF₃ | —N═S(Et)₂ | H | Cl | Cl | CF₃ | —N═S(Et)₂ | Cl |
| Br | Cl | CF₃ | —N═S(Et)₂ | H | Br | Cl | CF₃ | —N═S(Et)₂ | Cl |
| Me | Br | CF₃ | —N═S(Et)₂ | H | Me | Br | CF₃ | —N═S(Et)₂ | Cl |
| Cl | Br | CF₃ | —N═S(Et)₂ | H | Cl | Br | CF₃ | —N═S(Et)₂ | Cl |
| Br | Br | CF₃ | —N═S(Et)₂ | H | Br | Br | CF₃ | —N═S(Et)₂ | Cl |
| Me | CN | CF₃ | —N═S(Et)₂ | H | Me | CN | CF₃ | —N═S(Et)₂ | Cl |
| Cl | CN | CF₃ | —N═S(Et)₂ | H | Cl | CN | CF₃ | —N═S(Et)₂ | Cl |
| Br | CN | CF₃ | —N═S(Et)₂ | H | Br | CN | CF₃ | —N═S(Et)₂ | Cl |
| Me | Cl | Q-2 | —N═S(Et)₂ | H | Me | Cl | Q-2 | —N═S(Et)₂ | Cl |
| Cl | Cl | Q-2 | —N═S(Et)₂ | H | Cl | Cl | Q-2 | —N═S(Et)₂ | Cl |
| Br | Cl | Q-2 | —N═S(Et)₂ | H | Br | Cl | Q-2 | —N═S(Et)₂ | Cl |
| Me | Br | Q-2 | —N═S(Et)₂ | H | Me | Br | Q-2 | —N═S(Et)₂ | Cl |
| Cl | Br | Q-2 | —N═S(Et)₂ | H | Cl | Br | Q-2 | —N═S(Et)₂ | Cl |
| Br | Br | Q-2 | —N═S(Et)₂ | H | Br | Br | Q-2 | —N═S(Et)₂ | Cl |
| Me | CN | Q-2 | —N═S(Et)₂ | H | Me | CN | Q-2 | —N═S(Et)₂ | Cl |
| Cl | CN | Q-2 | —N═S(Et)₂ | H | Cl | CN | Q-2 | —N═S(Et)₂ | Cl |
| Br | CN | Q-2 | —N═S(Et)₂ | H | Br | CN | Q-2 | —N═S(Et)₂ | Cl |
| Me | Cl | Br | —N═S(i-Pr)₂ | H | Me | Cl | Br | —N═S(i-Pr)₂ | Cl |
| Cl | Cl | Br | —N═S(i-Pr)₂ | H | Cl | Cl | Br | —N═S(i-Pr)₂ | Cl |
| Br | Cl | Br | —N═S(i-Pr)₂ | H | Br | Cl | Br | —N═S(i-Pr)₂ | Cl |
| Me | Br | Br | —N═S(i-Pr)₂ | H | Me | Br | Br | —N═S(i-Pr)₂ | Cl |
| Cl | Br | Br | —N═S(i-Pr)₂ | H | Cl | Br | Br | —N═S(i-Pr)₂ | Cl |
| Br | Br | Br | —N═S(i-Pr)₂ | H | Br | Br | Br | —N═S(i-Pr)₂ | Cl |
| Me | CN | Br | —N═S(i-Pr)₂ | H | Me | CN | Br | —N═S(i-Pr)₂ | Cl |
| Cl | CN | Br | —N═S(i-Pr)₂ | H | Cl | CN | Br | —N═S(i-Pr)₂ | Cl |
| Br | CN | Br | —N═S(i-Pr)₂ | H | Br | CN | Br | —N═S(i-Pr)₂ | Cl |
| Me | Cl | Cl | —N═S(i-Pr)₂ | H | Me | Cl | Cl | —N═S(i-Pr)₂ | Cl |
| Cl | Cl | Cl | —N═S(i-Pr)₂ | H | Cl | Cl | Cl | —N═S(i-Pr)₂ | Cl |
| Br | Cl | Cl | —N═S(i-Pr)₂ | H | Br | Cl | Cl | —N═S(i-Pr)₂ | Cl |
| Me | Br | Cl | —N═S(i-Pr)₂ | H | Me | Br | Cl | —N═S(i-Pr)₂ | Cl |
| Cl | Br | Cl | —N═S(i-Pr)₂ | H | Cl | Br | Cl | —N═S(i-Pr)₂ | Cl |
| Br | Br | Cl | —N═S(i-Pr)₂ | H | Br | Br | Cl | —N═S(i-Pr)₂ | Cl |
| Me | CN | Cl | —N═S(i-Pr)₂ | H | Me | CN | Cl | —N═S(i-Pr)₂ | Cl |
| Cl | CN | Cl | —N═S(i-Pr)₂ | H | Cl | CN | Cl | —N═S(i-Pr)₂ | Cl |
| Br | CN | Cl | —N═S(i-Pr)₂ | H | Br | CN | Cl | —N═S(i-Pr)₂ | Cl |
| Me | Cl | CF₃ | —N═S(i-Pr)₂ | H | Me | Cl | CF₃ | —N═S(i-Pr)₂ | Cl |
| Cl | Cl | CF₃ | —N═S(i-Pr)₂ | H | Cl | Cl | CF₃ | —N═S(i-Pr)₂ | Cl |
| Br | Cl | CF₃ | —N═S(i-Pr)₂ | H | Br | Cl | CF₃ | —N═S(i-Pr)₂ | Cl |
| Me | Br | CF₃ | —N═S(i-Pr)₂ | H | Me | Br | CF₃ | —N═S(i-Pr)₂ | Cl |
| Cl | Br | CF₃ | —N═S(i-Pr)₂ | H | Cl | Br | CF₃ | —N═S(i-Pr)₂ | Cl |
| Br | Br | CF₃ | —N═S(i-Pr)₂ | H | Br | Br | CF₃ | —N═S(i-Pr)₂ | Cl |
| Me | CN | CF₃ | —N═S(i-Pr)₂ | H | Me | CN | CF₃ | —N═S(i-Pr)₂ | Cl |
| Cl | CN | CF₃ | —N═S(i-Pr)₂ | H | Cl | CN | CF₃ | —N═S(i-Pr)₂ | Cl |
| Br | CN | CF₃ | —N═S(i-Pr)₂ | H | Br | CN | CF₃ | —N═S(i-Pr)₂ | Cl |
| Me | Cl | Q-2 | —N═S(i-Pr)₂ | H | Me | Cl | Q-2 | —N═S(i-Pr)₂ | Cl |
| Cl | Cl | Q-2 | —N═S(i-Pr)₂ | H | Cl | Cl | Q-2 | —N═S(i-Pr)₂ | Cl |
| Br | Cl | Q-2 | —N═S(i-Pr)₂ | H | Br | Cl | Q-2 | —N═S(i-Pr)₂ | Cl |
| Me | Br | Q-2 | —N═S(i-Pr)₂ | H | Me | Br | Q-2 | —N═S(i-Pr)₂ | Cl |
| Cl | Br | Q-2 | —N═S(i-Pr)₂ | H | Cl | Br | Q-2 | —N═S(i-Pr)₂ | Cl |
| Br | Br | Q-2 | —N═S(i-Pr)₂ | H | Br | Br | Q-2 | —N═S(i-Pr)₂ | Cl |
| Me | CN | Q-2 | —N═S(i-Pr)₂ | H | Me | CN | Q-2 | —N═S(i-Pr)₂ | Cl |
| Cl | CN | Q-2 | —N═S(i-Pr)₂ | H | Cl | CN | Q-2 | —N═S(i-Pr)₂ | Cl |
| Br | CN | Q-2 | —N═S(i-Pr)₂ | H | Br | CN | Q-2 | —N═S(i-Pr)₂ | Cl |

In other embodiments, the pesticides can be other known anthranilic diamide insecticides, for example, those described in U.S. Pat. No. 8,324,390, US 2010/0048640, WO 2007/006670, WO 2013/024009, WO 2013/024010, WO 2013/024004, WO 2013/024170 or WO 2013/024003. Specific embodiments from U.S. Pat. No. 8,324,390 can include any of those compounds disclosed as examples 1 through 544. Specific embodiments from US 2010/0048640 can include any of those compounds disclosed in Tables 1 through 68 or compounds represented by Chemical Formula 44 through 118. Each of the references to the above patents and applications are hereby incorporated by reference.

Nematicides can also be included as a pesticide. Suitable examples can include, for example, avermectin nematicides, carbamate nematicides, and organophosphorous nematicides, abamectin, emamectin benzoate, benomyl, carbofuran, carbosulfan, cloethocarb, alanycarb, aldicarb, aldoxycarb, oxamyl, tirpate, diamidafos, fenamiphos, fosthietan, phosphamidon, cadusafos, chlorpyrifos, dichlofenthion, dimethoate, ethoprophos, fensulfothion, fosthiazate, heterophos, isamidofos, isazofos, phorate, phosphocarb, terbufos, thionazin, triazophos, imicyafos, mecarphon, acteoprole, benclothiay, chloropicrin, dazomet, fluensulfone, furfural, metam, methyl iodide, methyl isothiocyanate, xylenols, and a combination thereof. Nematicides also include nematicidally active biological organisms such as a bacteria or fungus. For example, Bacillus firmus, Bacillus cereus, Bacillus spp, Pasteuria spp, Pochonia chlamydosporia, Pochonia spp, and Streptomyces spp. A preferred nematicide according to an embodiment of the present invention is abamectin.

Fungicides can also be included. Suitable fungicides can include, for example, strobilurin fungicides, azole fungicides, conazole fungicides, triazole fungicides, amide fungicides, benzothiadiazole fungicides or a combination thereof. In other embodiments, the fungicides can include, azoyxstrobin, paclobutrazol, difenoconazole, isopyrazam, epoxiconazole, acibenzolar, acibenzolar-S-methyl, chlorothalonil, cyprodinil, fludioxonil, mandipropamid, picoxystrobin, propiconazole, pyraclostrobin, tebuconazole, thiabendazole, trifloxystrobin, mancozeb, chlorothalonil, metalaxyl-M (mefenoxam), metalaxyl, ametoctradin, prothioconazole, triadimenol, cyproconazole, sedaxane, cyprodinil, penconazole, boscalid, bixafen, fluopyram, penthiopyrad, fluazinam, fenpropidin, cyflufenamid, tebuconazole, trifloxystrobin, fluxapyroxad, penflufen, fluoxastrobin, kresoxim-methyl, benthiavalicarb, dimethomorph, amisulbrom, cyazofamid, flusulfamide, methyl thiophanate, triticonazole, flutriafol, thiram, tetraconazole, clothianidin, carboxin, thiodicarb, carbendazim, ipconazole, imazalil, penflufen, or a combination thereof. In still further embodiments, the fungicide can include fludioxonil, metalaxyl-M or a combination thereof.

The agricultural composition can also comprise a plant growth regulator. Suitable plant growth regulators can include, for example, potassium azide, 2-amino-4-chloro-6-methyl pyrimidine, N-(3,5-dichlorophenyl) succinimide, 3-amino-1,2,4-triazole, 2-chloro-6-(trichloromethyl)pyridine, sulfathiazole, dicyandiamide, thiourea, guanylthiourea or a combination thereof.

The agricultural composition can also comprise one or more Nod factors. As used herein, a “Nod factor” is a signal molecule, typically produced by a bacterium, for example, one or more of the Rhizobiaceae family, by means of which signal the bacterium is capable of infecting plants and inducing the formation of root nodosites. Bacteria infecting the roots produce nitrogen for the plants, while the plants carry away oxygen which would inhibit the nitrogenase activity. Nod factors are known in the art and typically comprise compounds known as lipochitooligosaccharides (LCDs). These LCOs have an acylated chitin backbone of 3 to 5 N-acetylated glucosamine rings with one of the terminal glucosamine rings acylated by a fatty acid, for example, an unsaturated or polyunsaturated fatty acid.

The agricultural composition can comprise or consist essentially of a fertilizer, macronutrients, micronutrients, a pesticide, a plant growth regulator, a Nod factor or a combination thereof. In some embodiments, the agricultural composition can consist of the fertilizer, pesticide, plant growth regulator or Nod Factor. In other embodiments, the agricultural composition can further comprise one or more liquid carriers, for example, water, one or more organic carriers or a combination thereof, and other additives that are common in the art. For example, a pesticide containing agricultural composition may include one or more wetting agents, dispersants, emulsifiers, defoaming agents, surfactants or other components as is well-known to those in the art.

The amount of the agricultural composition in the delayed release composition should be enough to provide a biologically effective amount of the agricultural composition. A “biologically effective amount of the agricultural composition” refers to that amount of a substance required to produce the desired effect on plant growth and/or yield. Effective amounts of the composition will depend on several factors, including treatment method, plant species, propagating material type and environmental conditions. For example, a biologically effective amount of one insecticide might be different than the biologically effective amount of a different insecticide. The biologically effective amount of a fungicide would be far different than the biologically effective amount of an ammonium fertilizer. One of ordinary skill in the art using known techniques would be able to determine the amount needed.

The delayed release composition can have an “S-shaped” or Gaussian release profile of the agricultural composition, where from 80 to 100 percent by weight of the agricultural composition is retained in the delayed release composition after the delayed release composition has been in contact with a growing medium for 1 to 8 weeks, and where in the range of from 80 and up to 100 percent of the agricultural composition is then released from the delayed release composition to the growing medium 2 to 30 weeks after placement in the growing medium, wherethe percentage by weight is based on the total amount of agricultural composition in the delayed release composition. In some embodiments, the delayed release is tuned to coincide with the fertilizer demand requirements of the growing plant. For example, the delayed release particle can be tuned to provide a growing corn plant with an amount of nitrogen fertilizer in order to maximize the yield of corn. In the initial stage of growth, i.e., up to about 60 days after planting, a growing corn plant requires only about 20 to 30 percent of its total nitrogen needs. However, from about day 60 after planting, up to about the harvest date, the corn plant requires 70 to 80 percent of the total nitrogen intake. The delayed release composition can provide the corn plant with an amount of nitrogen fertilizer that is timed to meet the demands of the growing plant.

In other embodiments, the disclosure relates to a method comprising the steps of;
a) placing the delayed release composition and a propagule in a growing medium wherein the propagule and the delayed release composition are distal to one another; and
b) allowing the propagule to germinate and the resulting plant to proliferate roots and grow;
wherein the delayed release composition comprises a core comprising a zeolite impregnated with an agricultural composition and a layer of a polymer composition on at least a portion of the core or wherein the delayed release composition comprises a continuous matrix of a polymer composition and, dispersed within the polymer matrix, a zeolite impregnated with an agricultural composition. The roots of the resultant plant elongate and proliferate at a distance which is proximal to the delayed release composition. In some embodiments, the distance between the propagule and the delayed release composition is in the range of from 1 centimeter to 40 centimeters. In other embodiments, the distance between the delayed release composition and the propagule is in the range of from 2 centimeters to 30 centimeters.

In some embodiments of the method, the delayed release composition is placed in the growing medium with the propagule at essentially the same time, while in other embodiments, the delayed release composition is placed in the growing medium before or after the propagule is placed in the growing medium. The placement of the delayed release composition can be in the range of several seconds before or after up to several days, for example, 1, 2, 3, 4, 5, 6 or 7 days before or after placement of the propagule. The delayed release composition is in the form of a granule, bead, prill, pellet or tablet. Any number of these granules, beads, prills, pellets or tablets can be co-located with the propagule. For example, the ratio of the granule, bead, prill, pellet or tablet per propagule can be in the range of from 50:1 to 1:10. In other embodiments, the ratio can be in the range of from 20:1 to 1:5, and, in still further embodiments, can be in the range of from 10:1 to 2:1. The size of the granule, bead, prill, pellet or tablet is not particularly important. In other embodiments, two or more delayed release compositions are co-located with a propagule, where each of the two or more delayed release compositions differ by the type of agricultural composition impregnating the zeolite.

### EXAMPLES

Unless otherwise noted, all ingredients are available from the Sigma Aldrich Company, St. Louis, Mo.

Clinoptilolite, mesh size 350 is available from St. Cloud Mining Co. Winston, N. Mex.

Zeolite X is available from Honeywell UOP, Mount Laurel, N.J.

Mordenite is available from Zeolyst International, Conshohocken, Pa.

Thiamethoxam is available from Syngenta Crop Protection, Greensboro, N.C.

BIONOLLE® 3020MD polybutylene succinate adipate film is available from Showa Denko, Osaka, Japan.

INGEO® 4032D polylactic acid film is available from NatureWorks LLC, Minnetonka, Minn.

ECOFILM® extruded film is available from Cortec Corporation, Minneapolis, Minn.

Preparation of Impregnated Zeolites

A saturated solution of fertilizer material was prepared. The saturated fertilizer solution was added to the dry zeolite powder dropwise until the surface of the powder appeared wet, but not waterlogged. The material was then placed in a vacuum oven set to 70° C. overnight to remove the water. This process was repeated two times, the zeolite powder was washed with water and dried in a vacuum oven set to 70° C. overnight with a slight nitrogen purge.

Various fertilizer impregnated zeolites were prepared using the above method. The fertilizers used were potassium nitrate, ammonium chloride and urea. An additional impregnated clinoptilolite was prepared using thiamethoxam.

In order to determine the amount of material that was absorbed by the zeolite, 4 grams of the impregnated zeolite was stirred in 1 liter of deionized water for 1 day. The zeolite was then filtered, washed with deionized water and dried in a vacuum oven overnight. The dry zeolite was weighed and the difference of the initial 4 gram sample and the dry weight was determined to be the amount of material absorbed in the zeolite.

Preparation of Impregnated Zeolite Pellets

The impregnated zeolite was placed in a Presco Hydraulic Press, Model PA2-1, S/N 1943. The material was pressed into a die at 9,071 kilograms of force.

### Example #1

4 gram pellets of nitrate impregnated clinoptilolite was prepared according to the procedures given above. Three nitrate impregnated pellets were separately wrapped with 50.8 micrometer thick film of BIONOLLE® 3020MD film. The film was heated with a heat gun until the polymer melted to the surface of the pellet. Each coated tablet was placed in a jar containing 400 milliliters (ml) of deionized water and the jar was sealed. As a control, three uncoated pellets were also placed in jars containing 400 ml of deionized water. Each jar was sealed. The jars were placed on a shaker table. After shaking for one week, the nitrate levels in the water was determined using a Hach INTELLICAL™ HQ430d benchtop meter equipped with a Hach INTELLICAL™ ISEN03181 nitrate ISE electrode, both available from Hach Company, Loveland, Colo. The samples continued to shake on the shaker table for 7 weeks at ambient temperature (22-25° C.) and the nitrate levels were tested. The results in TABLE 1 show the percentage of the potassium nitrate released from the pellet into the water and represent the average for the three replicates of each test.

TABLE 1

| | |
|---|---|
| Coated Zeolite | Uncoated Zeolites |

| Days | Average | STDEV | Average | STDEV |
|---|---|---|---|---|
| 1 | 2.3% | 4.0% | 100.0% | 0.0% |
| 3 | 3.7% | 6.5% | 100.0% | 0.0% |
| 7 | 5.8% | 10.0% | 100.0% | 0.0% |
| 10 | 8.0% | 12.7% | 100.0% | 0.0% |
| 14 | 19.1% | 26.9% | 100.0% | 0.0% |
| 21 | 53.5% | 21.5% | 100.0% | 0.0% |
| 28 | 81.4% | 14.3% | 100.0% | 0.0% |
| 35 | 92.4% | 15.2% | 100.0% | 0.0% |
| 49 | 91.7% | 15.8% | 100.0% | 0.0% |

### Example #2 Release into Tama Soil

4 gram pellets of nitrate impregnated clinoptilolite was prepared according to the procedures given above. Twenty seven of these 4 gram pellets were shrink-coated using a heat gun and 50.8 micrometers thick extruded BIONOLLE® 3020MD film. The film was wrapped around each pellet and heated until the polymer melted to the surface. The total weight of each pellet was recorded before the beginning of the experiment. 100 grams of tama soil (Stark County, Ill.) at field capacity was weighed into a small glass jar and the bead to be analyzed was placed in a central area. Each glass jar was covered with 3M™ BLENDERM™ Surgical Tape 1525-2 (3M, Minneapolis, Minn.). For each coated pellet, this was performed in triplicate to give three weekly sampling points for the 8 week long experiment. The glass jars were stored in a dark area at room temperature (22-25° C.) for the duration of the study. The coated pellets were removed, dried in a vacuum oven and weighed at the weekly sampling times (as well as the 1, 3, and 10 day time points). The polymer coating was removed from the bead and remaining nitrate was extracted from the bead using 0.04 M Ammonium Sulfate. The solution was then analyzed for nitrate concentration using a Hach INTELLICAL™ HQ430d Benchtop Meter equipped with a Hach INTELLICAL™ ISEN03181 Nitrate ISE Electrode to determine the amount of potassium nitrate remaining in the bead. The soil was mixed thoroughly before sampling and the 100 gram soil samples were transferred to 500 milliliters glass jars after sieving. For the extraction about 250 milliliters of the extraction solution (0.04 M ammonium sulfate) was added to each jar. The glass jars were sealed, shaken vigorously, and then placed on a shaker table overnight. The glass jars were left on a countertop until the soil settled to the bottom and provided a liquid top layer. The liquid top layer was then analyzed for nitrate concentration using a Hach INTELLICAL™ HQ430d Benchtop Meter equipped with a Hach INTELLICAL™ ISEN03181 Nitrate ISE Electrode. The probe was calibrated before each use. Table 2 shows the weight percentage of the nitrate released from the coated pellets.

TABLE 2

| Days | Average | STDEV |
|---|---|---|
| 1 | 1.8% | 0.6% |
| 3 | 0.9% | 0.3% |
| 7 | 0.9% | 0.5% |
| 10 | 2.7% | 3.2% |
| 14 | 8.3% | 12.1% |
| 21 | 6.3% | 5.5% |
| 28 | 53.0% | 32.2% |
| 42 | 60.6% | 28.0% |
| 56 | 95.4% | 2.4% |

### Example #3 Effect of Coating Thickness on Release Profile

4 gram pellets of nitrate impregnated clinoptilolite was prepared according to the procedures given above. Three of the pellets were wrapped with a 25.4 micrometer thick extruded film of INGOE® 4032D. The film was wrapped around the pellet and heated with a heat gun until the polymer melted to the surface of the pellet. Three pellets were wrapped with 4 layers of the 25.4 micrometer thick extruded INGEO® film to form a 101.6 micrometer film coating. The film layers were heated with a heat gun until the polymer melted to the surface of the pellet. The two types of pellets were then placed into sealed jars of 400 mL deionized water in triplicate, sealed and positioned on a shaker table. The nitrate levels were measured weekly using a Hach INTELLICAL™ HQ430d Benchtop Meter equipped with a Hach INTELLICAL™ ISEN03181 Nitrate ISE Electrode. The average weight percentage of the nitrate released from each pellet at the given time periods is shown in TABLE 3.

TABLE 3

| | | |
|---|---|---|
| Time | 25.4 μm Coating | 101.6 μm Coating |

| (weeks) | Average | STDEV | Average | STDEV |
|---|---|---|---|---|
| 1 | 1% | 2% | 0% | 0.0% |
| 2 | 7% | 11% | 0% | 0.0% |
| 3 | 5% | 4% | 0% | 0.0% |
| 4 | 8% | 5% | 0% | 0.0% |
| 5 | 15% | 10% | 0% | 0.0% |
| 6 | 16% | 9% | 0% | 0.0% |
| 7 | 16% | 9% | 0% | 0.0% |
| 8 | 22% | 11% | 0% | 0.0% |
| 9 | 22% | 11% | 0% | 0.0% |
| 10 | 25% | 11% | 0% | 0.0% |
| 11 | 26% | 12% | 0% | 0.0% |
| 12 | 41% | 16% | 0% | 0.1% |
| 13 | 41% | 17% | 0% | 0.6% |
| 14 | 53% | 11% | 1% | 0.6% |
| 15 | 55% | 9% | 1% | 1.3% |
| 16 | 61% | 5% | 4% | 2.4% |
| 17 | 65% | 4% | 9% | 6.6% |
| 18 | 67% | 4% | 38% | 15.1% |
| 19 | 70% | 5% | 49% | 14.4% |
| 20 | 78% | 11% | 51% | 14.6% |
| 21 | 82% | 8% | 53% | 17.5% |
| 22 | 86% | 4% | 56% | 18.8% |
| 23 | 85% | 6% | 58% | 18.1% |
| 24 | 88% | 2% | 62% | 17.7% |

Example 3 shows that the release rate of the agricultural composition can be increased or decreased by changing the thickness of the polymer coating layer.

### Example #4 Effect of Coating Type on the Release of Nitrate

4 gram pellets of nitrate impregnated clinoptilolite was prepared according to the procedures given above. 21 of these pellets were wrapped with 1 layer of 50.8 micrometer BIONOLLE® 3020MD film and the wrapped pellets were heated with a heat gun until the film adhered to the surface of the pellet. 18 of the pellets were inidividually wrapped with 2 layers of 25.4 micrometer ECOFILM® film and the wrapped pellets were heated with a heat gun until the film adhered to the surface of the pellet. An additional 21 of the pellets were wrapped with 25.4 micrometer extruded INGEO® 4032D polylactic acid film. The wrapped pellets were heated with a heat gun until the film adhered to the surface of the pellet.

100 grams of sassafras soil (Chesapeake Farms, Md.) at field capacity was weighed into small glass jars. A bead was placed in a central area of the jar, covered with the soil. Each jar was then covered with BLENDERM™ Surgical tape. For each sampling point, the test was performed in triplicate during the 7 week long experiment. ECOFILM® was only tested for 6 weeks. The filled glass jars were stored in the dark at ambient temperature (22-25° C.) for the duration of the study. The beads were removed, dried (in a vacuum oven), and weighed at weekly sampling times. The soil was mixed thoroughly before sampling and the 100 gram samples were transferred to 500 milliliter glass jars after sieving. For the extraction about 250 milliliter of the extraction solution (0.04 M ammonium sulfate) was added to each jar. The glass jars were sealed then shaken vigorously and placed on a shaker table overnight. The glass jars were left on a countertop until the soil settled to the bottom and provided a liquid top layer. This was then analyzed for nitrate concentration using a Hach IntelliCAL™ HQ430d Benchtop Meter equipped with a Hach IntelliCAL™ ISEN03181 Nitrate ISE Electrode. The probe was calibrated before each use. The average weight percentage of the nitrate released from each pellet at the given time periods is shown in TABLE 4.

TABLE 4

| | 50.8 μm | | | | | |
|---|---|---|---|---|---|---|
| | BIONOLLE ® | | 50.8 μm | | 25.4 μm | |
| | 3020MD | | ECOFILM ® | | INGEO ® 4032D | |
| Days | Average | STDEV | Average | STDEV | Average | STDEV |
| 7 | 0.0% | 0.0% | 0.0% | 0.0% | 1.6% | 2.1% |
| 14 | 11.6% | 4.5% | 6.6% | 7.2% | 1.6% | 1.3% |
| 21 | 18.6% | 6.3% | 12.3% | 9.6% | 1.3% | 0.1% |
| 28 | 23.3% | 2.7% | 15.8% | 12.2% | 3.2% | 0.9% |
| 35 | 32.3% | 7.3% | 25.7% | 11.7% | 12.8% | 3.1% |
| 49 | 40.0% | 10.5% | 21.5% | 37.2% | 14.1% | 5.5% |
| 63 | 91.3% | 1.2% | | | 19.4% | 2.4% |

### Example #5 Effect of Zeolite Type on Release Characteristics

4 gram pellets of nitrate impregnated clinoptilolite was prepared according to the procedures given above. 4 gram pellets of nitrate impregnated Zeolite X was also prepared according to the procedures given above. Each of the six pellets was wrapped with 25.4 micrometer thick INGEO® 4032D film and the film was heated with a heat gun until the film adhered to the surface of the pellet. The pellets were then placed into jars containing 400 milliliters of deionized water in triplicate, sealed and positioned on a shaker table. The nitrate levels were measured weekly using a Hach INTELLICAL™ HQ430d Benchtop Meter equipped with a Hach INTELLICAL™ ISEN03181 Nitrate ISE Electrode. Table 5 shows the average amount of the nitrate released from each zeolite type over the course of the experiment.

TABLE 5

| | |
|---|---|
| Clinoptilonite | Zeolite X |

| Weeks | Average | STDEV | Average | STDEV |
|---|---|---|---|---|
| 1 | 0% | 0% | 2% | 2% |
| 2 | 0% | 1% | 4% | 1% |
| 3 | 1% | 2% | 6% | 0% |
| 4 | 3% | 3% | 7% | 1% |
| 5 | 5% | 5% | 8% | 1% |
| 6 | 7% | 7% | 9% | 1% |
| 7 | 9% | 9% | 9% | 2% |
| 8 | 13% | 11% | 12% | 2% |
| 9 | 17% | 12% | 13% | 3% |
| 10 | 18% | 11% | 14% | 2% |
| 11 | 19% | 11% | 14% | 2% |
| 12 | 31% | 15% | 21% | 3% |
| 13 | 32% | 15% | 22% | 2% |
| 14 | 32% | 15% | 23% | 3% |
| 15 | 33% | 15% | 24% | 2% |
| 16 | 34% | 16% | 25% | 1% |
| 17 | 35% | 16% | 25% | 2% |
| 18 | 35% | 16% | 25% | 2% |
| 19 | 36% | 15% | 23% | 5% |
| 20 | 38% | 15% | 25% | 2% |
| 21 | 41% | 16% | 26% | 2% |
| 22 | 39% | 14% | 26% | 3% |
| 23 | 41% | 16% | 27% | 2% |
| 24 | 41% | 16% | 27% | 2% |

### Example 6, Effect of Bead Size on Rate of Release

Six 4 gram pellets of nitrate impregnated clinoptilolite were prepared according to the procedures given above. Additionally three 8 gram pellets of nitrate impregnated clinoptilolite pellets were prepared according to the procedures given above. Each of the pellets was wrapped with 25.4 micrometer thick INGEO® 4032D film. The film was heated with a heat gun until the film adhered to the surface of the pellet. One 8 gram pellet and two 4 gram pellets were placed into sealed jars containing 400 milliliters of deionized water in triplicate, sealed and positioned on a shaker table. The nitrate levels were measured weekly using a Hach INTELLICAL™ HQ430d Benchtop Meter equipped with a Hach INTELLICAL™ ISEN03181 Nitrate ISE Electrode. Table 6 shows the average amount of the nitrate released from each zeolite type over the course of the experiment.

TABLE 6

| | |
|---|---|
| 2 × 4 g pellets | 8 g pellet |

| Days | average | stdev | average | stdev |
|---|---|---|---|---|
| 7 | 3.1% | 1.7% | 0.5% | 0.3% |
| 14 | 19.7% | 2.7% | 0.3% | 0.3% |
| 28 | 37.9% | 7.5% | 0.4% | 0.4% |
| 35 | 56.0% | 7.8% | 0.2% | 0.2% |
| 42 | 51.0% | 7.2% | 0.4% | 0.2% |
| 49 | 54.0% | 4.7% | 1.0% | 0.8% |
| 56 | 56.8% | 5.0% | 1.9% | 1.2% |
| 63 | 76.5% | 9.4% | 3.4% | 1.8% |

### Example 7, Effect of Different Fertilizer Payloads on the Rate of Release

4 gram pellets of nitrate impregnated clinoptilolite pellets were produced according to the procedures given above. 4 gram pellets of ammonium chloride impregnated clinoptilolite pellets were produced according to the procedures given above. 4 gram pellets of urea impregnated clinoptilolite pellets were produced according to the procedures given above. Each of the pellets were wrapped with 25.4 micrometer thick INGEO 4032D film and heated with a heat gun until the film adhered to the surface of the pellet. The three types of pellets were placed in jars containing 400 milliliters of deionized water in triplicate, sealed and positioned on a shaker table. The nitrate levels were measured weekly using a Hach INTELLICAL™ HQ430d Benchtop Meter equipped with a Hach INTELLICAL™ ISEN03181 Nitrate ISE Electrode. Table 6 shows the average amount of the nitrate released from each zeolite type over the course of the experiment. The ammonium levels were measured using a Hach INTELLICAL™ HQ430d Benchtop Meter equipped with a Hach INTELLICAL™ ISENH4181 Ammonium Ion Selective Electrode (ISE). The urea levels were measured using a BioAssay Systems QUNATICHROM™ Urea Assay Kit (DIUR-500) and a spectrophotometer (BioTek POWERWAVE™ XS Spectrophotometer, available from POWERWAVE™ XS2, 100 Tigan St., Winooski, Vt.). The average amounts of the potassium nitrate, ammonium chloride and urea released from the coated zeolite pellets is given in Table 7.

TABLE 7

| | Nitrate | | Ammonium | | Urea | |
|---|---|---|---|---|---|---|
| Weeks | Average | STDEV | Average | STDEV | Average | STDEV |
| 1 | 1% | 2% | 0% | 0% | 12% | 17% |
| 2 | 7% | 11% | 0% | 0% | 22% | 36% |
| 3 | 5% | 4% | 1% | 0% | 52% | 53% |
| 4 | 8% | 5% | 3% | 0% | 59% | 34% |
| 5 | 15% | 10% | 4% | 0% | 63% | 41% |
| 6 | 16% | 9% | 4% | 0% | 60% | 23% |
| 7 | 16% | 9% | 5% | 0% | 64% | 31% |
| 8 | 22% | 11% | 17% | 0% | 66% | 24% |
| 9 | 22% | 11% | 27% | 2% | 63% | 20% |
| 10 | 25% | 11% | 38% | 3% | 64% | 23% |
| 11 | 26% | 12% | 49% | 1% | 66% | 14% |
| 12 | 41% | 16% | 58% | 0% | 66% | 16% |
| 13 | 41% | 17% | 68% | 3% | 69% | 28% |

### Example 8, Release of Thiamethoxam from Clinoptilolite

4 gram pellets impregnated with thiamethoxam were prepared according to the procedures given above. Each of the pellets was wrapped with a 25.4 micrometer thick film of INGEO® 4032D film and heated with a heat gun until the film adhered to the surface of the pellet. The pellets were then placed in jars containing 400 milliliters of deionized water in triplicate, sealed and positioned on a shaker table. Aliquots were taken and stored in HPLC vials (diluted down and acidified) in the freezer until analysis. The thiamethoxam level in each sample was then determined by HPLC-UV. The average amount of thiamethoxam released is shown in Table 8.

TABLE 8

Thiamethoxam

| Weeks | Average | STDEV |
|---|---|---|
| 1 | 17% | 6% |
| 2 | 30% | 22% |
| 3 | 31% | 24% |
| 4 | 42% | 31% |
| 5 | 76% | 1% |
| 6 | 79% | 24% |
| 7 | 92% | 6% |
| 8 | 78% | 26% |
| 9 | 74% | 25% |
| 10 | 89% | 26% |
| 11 | 84% | 20% |
| 12 | 84% | 23% |
| 13 | 84% | 21% |

### Example 9, Measuring the Protective Effect of Zeolites from the Nitrification of Ammonium in Soil

10 g of dry clinoptilolite zeolite powder was heated in 1 liter of 10 percent ammonium chloride solution and was stirred for an hour once the liquid reached 60° C. Next, the solid was filtered off and the process was repeated three times. The resulting solid was dried overnight in a vacuum oven at 60° C. After the cation exchange process, a saturated solution of potassium nitrate was prepared. This was added to dry zeolite powder drop-wise until the surface of the powder appeared wet, but not waterlogged. The material was then placed in a vacuum oven overnight at 70° C. to remove the water. This process was repeated two more times, the material was washed, and the dried completely in a vacuum oven with nitrogen purge overnight at 70° C.

Two large polyethylene bags (VW R#89071-848) were each filled with 500 g of Sassafras Soil (Chesapeake Farms, Md.) at field capacity. Ammonium chloride (6.68 mmol N) was added to one of the bags and the loaded zeolites (6.68 mmol N) were added to the other bag. The bags were thoroughly shaken and then placed in a cabinet at 20° C. At a given time point, the bags were removed from the cabinet, the soil was mixed, and then three-20 g soil samples were removed. The ammonium/nitrate was extracted using 2M potassium chloride solution. The solution was analyzed for ammonium/nitrate concentration using calorimetry.

TABLE 9

| | Ammonium Chloride | | | | | | | |
|---|---|---|---|---|---|---|---|---|
| | (comparative) | | | | Zeolite | | | |
| | Ammonium | | Nitrate | | Ammonium | | Nitrate | |
| | Aver- | | Aver- | | Aver- | | Aver- | |
| Days | age | STDEV | age | STDEV | age | STDEV | age | STDEV |
| 1 | 13.2 | 1.6 | 6.3 | 0.8 | 10.1 | 3.6 | 372.6 | 2.7 |
| 7 | 12.8 | 1.5 | 13.5 | 1.4 | 7.2 | 2.0 | 284.8 | 36.2 |
| 14 | 11.6 | 2.2 | 17.7 | 4.6 | 8.2 | 2.7 | 341.7 | 26.2 |
| 21 | 13.8 | 0.5 | 19.2 | 0.7 | 10.9 | 0.9 | 313.6 | 10.1 |
| 28 | 12.3 | 1.8 | 20.7 | 2.7 | 12.6 | 1.5 | 326.4 | 18.5 |
| 35 | 11.7 | 1.3 | 23.8 | 3.7 | 9.6 | 4.0 | 385.0 | 122.5 |
| 42 | 12.2 | 1.0 | 23.7 | 1.0 | 10.2 | 0.9 | 334.6 | 30.1 |
| 49 | 14.6 | 0.4 | 27.7 | 1.1 | 12.2 | 0.8 | 403.9 | 19.8 |

### Example 10, Effect of Temperature on Nitrogen Release

Nine clinoptillonite zeolite 4 g pellets containing potassium nitrate were prepared according the procedure above. The pellets were shrink-coated using a heat gun and 25.4 um thick extruded PLA film (Natureworks LLC, Minetonka, Minn., Ingeo 4032D). The film piece was wrapped around the pellet and heated until the polymer melted to the surface of the pellet. The pellets were then placed into separate sealed jars of 400 mL deionized water. Three of the jars were placed in a cold room at 15° C., three were place in a room at 22° C., and three were placed in a room at 30° C. The nitrate levels were measured weekly using a Hach IntelliCAL™ HQ430d Benchtop Meter equipped with a Hach IntelliCAL™ ISEN03181 Nitrate ISE Electrode. Results are shown in Table 10, below. As anticipated, the release rate was dependent on the temperature.

TABLE 10

| | 15 C. | | 22 C. | | 30 C. | |
|---|---|---|---|---|---|---|
| | Average | | Average | | Average | |
| | Nitrate | | Nitrate | | Nitrate | |
| week | Released (g) | SD | Released (g) | SD | Released (g) | STDEV |
| 1 | 0.001 | 0.000 | 0.008 | 0.012 | 0.027 | 0.044 |
| 2 | 0.001 | 0.000 | 0.039 | 0.067 | 0.134 | 0.112 |
| 3 | 0.005 | 0.001 | 0.027 | 0.027 | 0.149 | 0.091 |
| 4 | 0.007 | 0.003 | 0.048 | 0.029 | 0.143 | 0.016 |
| 5 | 0.015 | 0.007 | 0.093 | 0.061 | 0.154 | 0.018 |
| 6 | 0.036 | 0.004 | 0.093 | 0.056 | 0.170 | 0.016 |
| 7 | 0.059 | 0.022 | 0.097 | 0.056 | 0.266 | 0.026 |
| 8 | 0.087 | 0.043 | 0.130 | 0.068 | 0.287 | 0.031 |
| 9 | 0.109 | 0.039 | 0.132 | 0.065 | 0.310 | 0.032 |
| 10 | — | — | 0.148 | 0.068 | 0.389 | 0.069 |
| 11 | — | — | 0.157 | 0.074 | 0.417 | 0.062 |
| 12 | 0.147 | 0.030 | 0.244 | 0.099 | — | — |
| 13 | 0.153 | 0.028 | 0.245 | 0.099 | — | — |
| 14 | 0.164 | 0.021 | 0.316 | 0.064 | — | — |
| 15 | 0.174 | 0.025 | 0.332 | 0.051 | — | — |
| 16 | 0.203 | 0.050 | 0.368 | 0.028 | — | — |
| 17 | 0.210 | 0.046 | 0.393 | 0.027 | — | — |
| 18 | 0.259 | 0.069 | 0.403 | 0.027 | — | — |
| 19 | 0.264 | 0.068 | 0.423 | 0.031 | — | — |
| 20 | — | — | 0.466 | 0.064 | — | — |
| 21 | — | — | 0.490 | 0.048 | — | — |
| 22 | — | — | 0.518 | 0.025 | — | — |
| 23 | — | — | 0.510 | 0.036 | — | — |
| 24 | — | — | 0.527 | 0.013 | — | — |

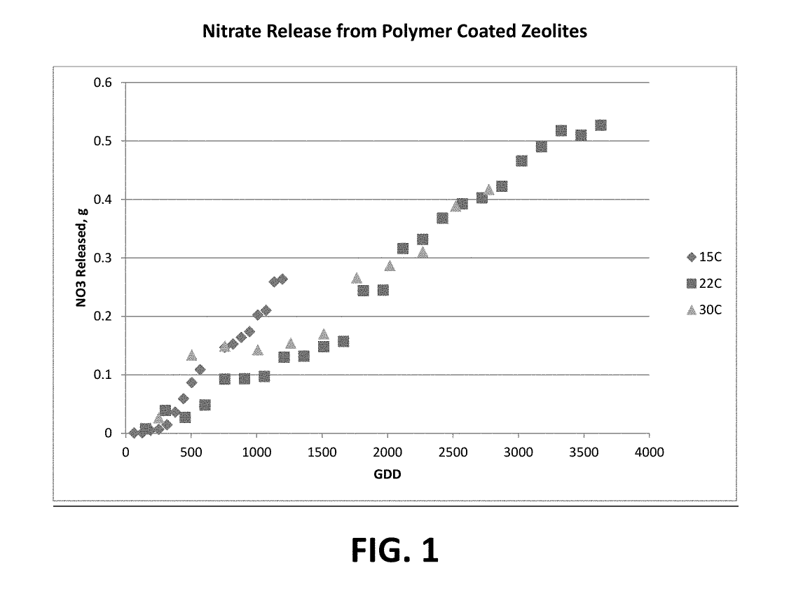

The results from Table 10 were converted into Grower Degree Days (GDD) using the following formula:

$$G D D = \frac{{T}_{max} + {T}_{min}}{2} - {T}_{base}$$

where Tₘₐₓ and Tₘᵢₙ are the highest and lowest temperatures in a 24 hour period, respectively, and T_{base} is 10° C. As shown in FIG. 1, the nitrogen release rates, based on GDD, is very similar at 22° C. and 30° C., which suggests fluctuations in temperature would not negatively affect the nitrogen release during a growing season.

### Example 11, Effect of Moisture on Nitrogen Release

One hundred eight clinoptillonite zeolite 4 g pellets containing potassium nitrate were prepared according the procedure above. All pellets were shrink-coated using a heat gun and 25.4 um thick PLA (Natureworks LLC, Minetonka, Minn., Ingeo 4032D). 100 g of Tama soil (Illinois) was weighed into a small glass jar and the bead to be analyzed was placed in a central area. Water was added to the jars to achieve three different moisture levels, 13.1%, 30.6%, and 66.7% corresponding to wilt point, field capacity, and saturation respectively. The beads were separated into three sets, and one set was run at each moisture level. Each glass jar was covered with 3M™ Blenderm™ Surgical Tape 1525-2 (3M, Minneapolis, Minn.). For each bead-type, this was performed in triplicate to give three weekly sampling points for the 12 week long experiment. Samples were stored in a dark area at room temperature (22-25° C.) for the duration of the study. The beads were removed, dried (in a vacuum oven), and weighed at weekly sampling times. Soil was then frozen before extraction, if the extraction was not carried out immediately. The soil was mixed thoroughly before sampling and the 100 g samples were transferred to 500 mL glass jars after sieving. For the extraction −250 mL of the extraction solution (0.04 M Ammonium Sulfate) was added to each jar. The glass jars were shaken vigorously, and then placed on a shaker table overnight. The glass jars were left on a countertop until the soil settled to the bottom and provided a liquid top layer. This was then analyzed for nitrate concentration using a Hach IntelliCAL™ HQ430d Benchtop Meter equipped with a Hach IntelliCAL™ ISEN03181 Nitrate ISE Electrode. The probe was calibrated before each use. The results are shown in table 11. As shown in Table 11, the release rate of nitrate from polymer coated zeolites at 12 weeks is not dependent on the level of moisture in the soil.

TABLE 11

| | 13.1% Moisture | | 30.6% Moisture | | 66.7% Moisture | |
|---|---|---|---|---|---|---|
| | Average | | Average | | Average | |
| | NO3 | | NO3 | | NO3 | |
| | into Soil | | into Soil | | into Soil | |
| Week | (mg) | STDEV | (mg) | STDEV | (mg) | STDEV |
| 1 | 2.65 | 0.34 | 2.37 | 0.09 | 7.71 | 7.83 |
| 2 | 3.03 | 0.30 | 3.85 | 1.29 | 9.76 | 12.34 |
| 4 | 4.27 | 2.11 | 9.06 | 10.99 | 14.77 | 16.33 |
| 6 | 3.37 | 1.16 | 9.70 | 12.94 | 8.15 | 4.66 |
| 8 | 4.42 | 2.21 | 6.85 | 5.98 | 12.73 | 5.33 |
| 10 | 5.96 | 3.12 | 26.19 | 18.12 | 13.38 | — |
| 12 | 37.29 | 0.19 | 36.38 | 2.38 | 37.71 | 6.65 |

What is claimed is:

1. A delayed release composition comprising:
a) a core comprising a zeolite impregnated by an agricultural composition; and
b) a layer of a polymer composition on at least a portion of the core,
wherein the agricultural composition comprises a fertilizer, a pesticide, a plant growth regulator, a Nod factor or a combination thereof, and wherein the polymer composition comprises a polymer and, wherein the polymer is a polylactic acid polymer, polylactic acid glycolic acid copolymer, polybutylene succinate adipate copolymer, a polybutylene succinate copolymer or a blend thereof.

2. A delayed release composition comprising:
a1) a continuous matrix of a polymer composition; and
b1) dispersed within the polymer matrix, a zeolite impregnated with an agricultural composition,
wherein the agricultural composition comprises a fertilizer, macronutrients, micronutrients, a pesticide, a plant growth regulator, a Nod factor or a combination thereof, and wherein the polymer composition comprises a polymer and, wherein the polymer is a polylactic acid polymer, polylactic acid glycolic acid copolymer, polybutylene succinate adipate copolymer, a polybutylene succinate copolymer or a blend thereof.

3. The delayed release composition of claim 1 wherein the layer of the polymer composition has a thickness in the range of from 20 to 260 micrometers.

4. The delayed release composition of claim 1 wherein the core is in the form of a granule, bead, prill, pellet or tablet.

5. The delayed release composition of claim 1 wherein the fertilizer comprises reduced nitrogen compounds, unreduced nitrogen compounds, phosphorous and potassium compounds, sulfur, calcium, magnesium, boron, iron, copper, manganese, zinc or a combination thereof.

6. The delayed release composition of claim 2 further comprising a weight ratio of polymer matrix to impregnated zeolite in the range of from 100:1 to 1:5, based on total weight of the delayed release composition.

7. The delayed release composition of claim 1 wherein the pesticide is an insecticide, fungicide, nematicide, herbicide or a combination thereof.

8. The delayed release composition of claim 1 wherein the insecticide is an anthranilic diamide, N-oxides, or salts thereof, neonicotinoid, carbamate, diamide, spinosyn, phenylpyrazole, pyrethroid or a combination thereof.

9. The delayed release composition of claim 1 wherein the insecticide is sulfoxaflor, thiamethoxam, clothianidin, imidacloprid, acetamiprid, dinotefuran, nitenpyram, thiacloprid, thiodicarb, aldicarb, carbofuran, furadan, fenoxycarb, carbaryl, sevin, ethienocarb, fenobucarb, chlorantraniliprole, cyantraniliprole, flubendiamide, spinosad, spinetoram, lambda-cyhalothrin, gamma-cyhalothrin, tefluthrin, fipronil, pyrometrizine, deltamethrin, methiocarb, permethrin, fipronil, thiram, or a combination thereof.

10. The delayed release composition of claim 1 wherein from 80 to 100 percent by weight of the agricultural composition is retained in the delayed release composition after the delayed release composition has been in contact with a growing medium for 1 to 8 weeks, and wherein in the range of from 80 and up to 100 percent of the agricultural composition is then released from the delayed release composition to the growing medium 2 to 30 weeks after placement in the growing medium, wherein the percentage by weight is based on the total amount of agricultural composition in the delayed release composition.

11. The delayed release composition of claim 1 wherein the agricultural composition comprises strobilurin fungicides, azole fungicides, conazole fungicides, triazole fungicides, amide fungicides, benzothiadiazole fungicides or a combination thereof.

12. A method comprising:
i. placing the delayed release composition of claim 1 and a propagule in a growing medium wherein the propagule and the delayed release composition are distal to one another;
ii. allowing the propagule to germinate and the resultant plant to proliferate roots and grow;
wherein the roots of the plant elongate and proliferate at a distance which is proximal to the delayed release composition.

13. The method of claim 12 wherein the propagule and the delayed release composition are placed at a distance in the range of from 1 centimeter to 40 centimeters to one another.

14. The method of claim 12 wherein 80 to 100 percent by weight of the agricultural composition is retained in the delayed release composition after the delayed release composition has been in contact with the growing medium for 1 to 8 weeks, and wherein in the range of from 80 and up to 100 percent of the agricultural composition is then released from the delayed release composition to the growing medium 2 to 30 weeks after placement in the growing medium, wherein the percentage by weight is based on the total amount of agricultural composition in the delayed release composition.

15. The method of claim 12 wherein 0 to 20 percent of the agricultural composition is released in the range of from 0 to 19 days after placing the delayed release composition in the growing medium.

16. The method of claim 12 wherein the ratio of the delayed release composition per propagule is in the range of from 50:1 to 1:10.

17. The method of claim 12 wherein two or more delayed release compositions are co-located with a propagule, wherein each of the two or more delayed release compositions differ by the type of agricultural composition.
